(19) United States
(12) Patent Application Publication
(10) Pub. No.: US 2020/0097081 A1
(43) Pub. Date: Mar. 26, 2020

(54) NEUROMUSCULAR CONTROL OF AN AUGMENTED REALITY SYSTEM

(71) Applicants: Jasmine Stone, Austin, TX (US); Lana Awad, Long Island City, NY (US); Qiushi Mao, Brooklyn, NY (US); Christopher Osborn, Brooklyn, NY (US); Daniel Wetmore, Brooklyn, NY (US)

(72) Inventors: Jasmine Stone, Austin, TX (US); Lana Awad, Long Island City, NY (US); Qiushi Mao, Brooklyn, NY (US); Christopher Osborn, Brooklyn, NY (US); Daniel Wetmore, Brooklyn, NY (US)

(21) Appl. No.: 16/577,207

(22) Filed: Sep. 20, 2019

Related U.S. Application Data
(60) Provisional application No. 62/734,145, filed on Sep. 20, 2018.

(51) Int. Cl. G06F 3/01; G06F 16/583; G06K 9/00; G06T 7/70; G06T 19/00

(52) U.S. Cl. CPC G06F 3/015; G06F 16/583; G06F 3/017; G06T 19/006; G06K 9/00335; G06T 7/70; G06K 9/00671

(57) ABSTRACT

Computerized systems, methods, kits, and computer-readable storage media storing code for implementing the methods are provided for controlling an extended reality (XR) system. One such system includes: one or more neuromuscular sensors that sense neuromuscular signals from a user, and at least one computer processor. The neuromuscular sensor(s) is or are arranged on one or more wearable devices structured to be worn by the user to sense the neuromuscular signals. The at least one computer processor is or are programmed to: identify a first muscular activation state of the user based on the neuromuscular signals; determine, based on the first muscular activation state, an operation of an XR system to be controlled; identify a second muscular activation state of the user based on the neuromuscular signals; and output, based on the second muscular activation state, a control signal to the XR system to control the operation of the XR system.

### CROSS-REFERENCE TO RELATED APPLICATIONS

This application claims the benefit under 35 U.S.C. § 119(e) of U.S. Provisional Patent Application Ser. No. 62/734,145, filed Sep. 20, 2018, entitled “NEUROMUSCULAR CONTROL OF AN AUGMENTED REALITY SYSTEM,” the entire contents of which is incorporated by reference herein.

### FIELD OF THE INVENTION

The present technology relates to systems and methods that detect and interpret neuromuscular signals for use in performing functions in an augmented reality (AR) environment as well as other types of extended reality (XR) environments, such as a virtual reality (VR) environment, a mixed reality (MR) environment, and the like.

### BACKGROUND

Augmented reality (AR) systems provide users with an interactive experience of a real-world environment supplemented with virtual information by overlaying computer-generated perceptual or virtual information on aspects of the real-world environment. Various techniques exist for controlling operations of an AR system. Typically, one or more input devices, such as a controller, a keyboard, a mouse, a camera, a microphone, and the like, may be used to control operations of the AR system. For example, a user may manipulate a number of buttons on an input device, such as a controller or a keyboard, to effectuate control of the AR system. In another example, a user may use voice commands to control operations of the AR system. The current techniques for controlling operations of an AR system have many flaws, so improved techniques are needed.

### SUMMARY

According to aspects of the technology described herein, a computerized system for controlling an augmented reality (AR) system based on neuromuscular signals is provided. The system may comprise a plurality of neuromuscular sensors configured to record a plurality of neuromuscular signals from a user, and at least one computer processor. The plurality of neuromuscular sensors may be arranged on one or more wearable devices. The at least one computer processor may be programmed to: identify a first muscular activation state of the user based on the plurality of neuromuscular signals, determine, based on the first muscular activation state, an operation of the augmented reality system to be controlled; identify a second muscular activation state of the user based on the plurality of neuromuscular signals; and provide, based on the second muscular activation state, a control signal to the AR system to control the operation of the AR reality system.

In an aspect, the first muscular activation state, or the second muscular activation state, or both the first and second muscular activation states may comprise a static gesture performed by the user.

In another aspect, the first muscular activation state, or the second muscular activation state, or both the first and second muscular activation states may comprise a dynamic gesture performed by the user.

In an aspect, the first muscular activation state, or the second muscular activation state, or both the first and second muscular activation states may comprise a sub-muscular activation state.

In another aspect, the first muscular activation state, or the second muscular activation state, or both the first and second muscular activation states may comprise a muscular tensing performed by the user.

In an aspect, the first muscular activation state is same as the second muscular activation state.

In another aspect, the control signal comprises a signal for controlling any one or any combination of: a brightness of a display device associated with the AR system, an attribute of an audio device associated with the AR system, a privacy mode or privacy setting of one or more devices associated with the AR system, a power mode or a power setting of the AR system, an attribute of a camera device associated with the AR system, a display of content by the AR system, information to be provided by the AR system, communication of information associated with the AR system to a second AR system, a visualization of the user generated by the AR system, and a visualization of an object or a person other than the user, wherein the visualization is generated by the AR system.

In an aspect, the at least one computer processor may be programmed to present to the user via a user interface displayed in an AR environment provided by the AR system, one or more instructions about how to control the operation of the AR system.

In a variation of this aspect, the one or more instructions may include a visual demonstration of how to achieve the first muscular activation state, or the second muscular activation state, or both the first and second muscular activation states.

In another aspect, the at least one computer processor may be programmed to receive information from the AR system indicating a current state of the AR system, wherein the plurality of neuromuscular signals are interpreted based on the received information.

In an aspect, the AR system may be configured to operate in a first mode. The at least one computer processor may be programmed to: identify a third muscular activation state of the user based on the plurality of neuromuscular signals; and change, based on the third muscular activation state, an operation mode of the AR system from the first mode to a second mode. The second mode may be a mode for controlling operations of the AR system. The third muscular activation state may be identified prior to the first and second muscular activation states.

In another aspect, the at least one computer processor is further programmed to: identify a plurality of second muscular activation states of the user based on the plurality of neuromuscular signals; and provide, based on the plurality of second muscular activation states, a plurality of control signals to the AR system to control the operation of the AR system. The plurality of second muscular activation states may include the second muscular activation state.

In a variation of this aspect, the at least one computer processor may be programmed to: identify a plurality of third muscular activation states of the user based on the plurality of neuromuscular signals; and provide, based on the plurality of second muscular activation states, or the plurality of third muscular activation states, or both the plurality of second muscular activation states and the plurality of third muscular activation states, the plurality of control signals to the AR system to control the operation of the AR system.

According to aspects of the technology described herein, a method for controlling an augmented reality (AR) system based on neuromuscular signals is provided. The method may comprise: recording, using a plurality of neuromuscular sensors arranged on one or more wearable devices, a plurality neuromuscular signals from a user; identifying a first muscular activation state of the user based on the plurality of neuromuscular signals; determining, based on the first muscular activation state, an operation of the augmented reality system to be controlled; identifying a second muscular activation state of the user based on the plurality of neuromuscular signals; and providing, based on the second muscular activation state, a control signal to the AR system to control the operation of the AR system.

According to aspects of the technology described herein, a computerized system for controlling an augmented reality (AR) system based on neuromuscular signals is provided. The system may comprise a plurality of neuromuscular sensors configured to record a plurality of neuromuscular signals from a user, and at least one computer processor. The plurality of neuromuscular sensors may be arranged on one or more wearable devices. The at least one computer processor may be programmed to: identify a muscular activation state of the user based on the plurality of neuromuscular signals; determine, based on the muscular activation state, an operation of the AR system to be controlled; and provide, based on the muscular activation state, a control signal to the AR system to control the operation of the AR system.

In an aspect, the control signal may comprise a signal for controlling any one or any combination of: a brightness of a display device associated with the AR system, an attribute of an audio device associated with the AR system, a privacy mode or privacy setting of one or more devices associated with the AR system, a power mode or a power setting of the AR system, an attribute of a camera device associated with the AR system, a display of content by the AR system, information to be provided by the AR system, communication of information associated with the AR system to a second AR system, a visualization of the user generated by the AR system, and a visualization of an object or a person other than the user, wherein the visualization is generated by the AR system.

In another aspect, the at least one computer processor may be programmed to present to the user, via a user interface displayed in an AR environment provided by the AR system, one or more instructions about how to control the operation of the AR system.

In a variation of this aspect, the one or more instructions may include a visual demonstration of how to achieve the first muscular activation state, or the second muscular activation state, or both the first and second muscular activation states.

In an aspect, the at least one computer processor may be programmed to receive information from the AR system indicating a current state of the AR system, wherein the plurality of neuromuscular signals are interpreted based on the received information.

According to aspects of the technology described herein, a computerized system for controlling an extended reality (XR) system based on neuromuscular signals is provided. The system may comprise one or more neuromuscular sensors that sense and neuromuscular signals from a user, wherein the one or more neuromuscular sensors is or are arranged on one or more wearable devices structured to be worn by the user to sense the neuromuscular signals; and at least one computer processor. The at least computer processor may be programmed to: identify a first muscular activation state of the user based on the neuromuscular signals; determine, based on the first muscular activation state, an operation of an XR system to be controlled; identify a second muscular activation state of the user based on the neuromuscular signals; and output, based on the second muscular activation state, a control signal to the XR system to control the operation of the XR system.

In an aspect, the XR system may comprise an augmented reality (AR) system.

In another aspect, the XR system may comprise any one or any combination of: an augmented reality (AR) system, a virtual reality (VR) system, and a mixed reality (MR) system.

In an aspect the one or more neuromuscular sensors may comprise at least one electromyography (EMG) sensor.

In another aspect, the first muscular activation state, or the second muscular activation state, or both the first and second muscular activation states may comprise a static gesture as detected from the user.

In an aspect, the first muscular activation state, or the second muscular activation state, or both the first and second muscular activation states may comprise a dynamic gesture as detected from the user.

In another aspect, the first muscular activation state, or the second muscular activation state, or both the first and second muscular activation states may comprise a sub-muscular activation state as detected from the user.

In an aspect, the first muscular activation state and the second muscular activation state may be a same activation state.

In an aspect, the operation of the XR system to be controlled, which is determined based on the first muscular activation state, comprises an operation of a wake-up mode of the XR system.

In a variation of this aspect, the control signal, which is output by the at least one computer processor based on the second muscular activation state, controls an initialization operation of the XR system.

In another aspect, the control signal may comprise a signal that controls one or both of an attribute and a function of a display device associated with the XR system.

In an aspect, the control signal may comprise a signal that controls one or both of an attribute and a function of an audio device associated with the XR system.

In another aspect, the control signal may comprise a signal that controls a privacy mode or a privacy setting of one or more devices associated with the XR system.

In an aspect, the control signal may comprise a signal that controls a power mode or a power setting of the XR system.

In another aspect, the control signal may comprise a signal that controls one or both of an attribute and a function of a camera device associated with the XR system.

In an aspect, the control signal may comprise a signal that controls a display of content by the XR system.

In another aspect, the control signal may comprise a signal that controls information to be provided by the XR system.

In an aspect, the control signal may comprise a signal that controls communication of information associated with the XR system to a second XR system.

In another aspect, the control signal may comprise a signal that controls a visualization of the user generated by the XR system.

In an aspect, the control signal may comprise a signal that controls a visualization of an object generated by the XR system.

In another aspect, the at least one computer processor may be programmed to cause a user interface, which is displayed in an XR environment provided by the XR system, to present to the user one or more instructions on how to control the operation of the XR system.

In a variation of this aspect, the one or more instructions may include a visual demonstration of how to achieve the first muscular activation state, or the second muscular activation state, or both the first and second muscular activation states.

In a variation of this aspect, the at least one processor may be programmed to: determine a muscular activation state of the user, based on the neuromuscular signals; and provide feedback to the user via the user interface, the feedback comprising any one or any combination of: information on whether the determined muscular activation state may be used to control the XR system, information on whether the determined muscular activation state has a corresponding control signal, information on a control operation corresponding to the determined muscular activation state, and a query to the user to confirm that the XR system is to be controlled to perform an operation corresponding to the determined muscular activation state. The user interface may comprise any one or any combination of: an audio interface, a video interface, a tactile interface, and an electrical stimulation interface.

In another aspect, the at least one computer processor may be programmed to receive information from the XR system indicating a current state of the XR system. The neuromuscular signals may be interpreted based on the received information.

In an aspect, the XR system may comprise a plurality of operational modes. The at least one computer processor may be programmed to: identify a third muscular activation state of the user based on the neuromuscular signals; and change, based on the third muscular activation state, an operation of the XR system from a first mode to a second mode, the second mode being a mode for controlling operations of the XR system.

In another aspect, the at least one computer processor may be programmed to: identify a plurality of second muscular activation states of the user based on the neuromuscular signals; and output, based on the plurality of second muscular activation states, a plurality of control signals to the XR system to control the operation of the XR system.

In a variation of this aspect, the at least one computer processor may be programmed to: identify a plurality of third muscular activation states of the user based on the neuromuscular signals; and output, based on the plurality of second muscular activation states, or the plurality of third muscular activation states, or both the plurality of the second muscular activation states and the plurality of third muscular activation states, a plurality of control signals to the XR system to control an operation of the XR system.

According to aspects of the technology described herein, a method for controlling an extended reality (XR) system based on neuromuscular signals is provided. The method may include comprise: receiving, by at least one computer processor, neuromuscular signals sensed from a user by one or more neuromuscular sensors arranged on one or more wearable devices worn by the user; identifying, by the least one computer processor, a first muscular activation state of the user based on the neuromuscular signals; determining, by the least one computer processor based on the first muscular activation state, an operation of an XR system to be controlled; identifying, by the least one computer processor, a second muscular activation state of the user based on the neuromuscular signals; and outputting, by the least one computer processor based on the second muscular activation state, a control signal to the XR system to control the operation of the XR system.

In an aspect, the XR system may comprise an augmented reality (AR) system.

In another aspect, the XR system may comprise any one or any combination of: an augmented reality (AR) system, a virtual reality (VR) system, and a mixed reality (MR) system.

In an aspect, wherein the one or more neuromuscular sensors may comprise at least one electromyography (EMG) sensor.

In another aspect, the first muscular activation state, or the second muscular activation state, or both the first and second muscular activation states may comprise a static gesture as detected from the user.

In an aspect, the first muscular activation state, or the second muscular activation state, or both the first and second muscular activation states may comprise a dynamic gesture as detected from the user.

In another aspect, the first muscular activation state, or the second muscular activation state, or both the first and second muscular activation states may comprise a sub-muscular activation state as detected from the user.

In an aspect, the first muscular activation state and the second muscular activation state may be a same activation state.

In an aspect, the operation of the XR system to be controlled, which is determined based on the first muscular activation state, comprises an operation of a wake-up mode of the XR system.

In a variation of this aspect, the control signal, which is output by the at least one computer processor based on the second muscular activation state, controls an initialization operation of the XR system.

In another aspect, the control signal may comprise a signal that controls one or both of an attribute and a function of a display device associated with the XR system.

In an aspect, the control signal may comprise a signal that controls one or both of an attribute and a function of an audio device associated with the XR system.

In another aspect, the control signal may comprise a signal that controls a privacy mode or a privacy setting of one or more devices associated with the XR system.

In an aspect, the control signal may comprise a signal that controls a power mode or a power setting of the XR system.

In another aspect, the control signal may comprise a signal that controls one or both of an attribute and a function of a camera device associated with the XR system.

In an aspect, the control signal may comprise a signal that controls a display of content by the XR system.

In another aspect, the control signal may comprise a signal that controls information to be provided by the XR system.

In an aspect, the control signal may comprise a signal that controls communication of information associated with the XR system to a second XR system.

In another aspect, the control signal may comprise a signal that controls a visualization of the user generated by the XR system.

In an aspect, the control signal may comprise a signal that controls a visualization of an object generated by the XR system.

In another aspect, the method may comprise: causing, by the at least one computer processor, a user interface displayed in an XR environment provided by the XR system to present one or more instructions on how to control the operation of the XR system.

In a variation of this aspect, the one or more instructions may include a visual demonstration of how to achieve the first muscular activation state, or the second muscular activation state, or both the first and second muscular activation states.

In another variation of this aspect, the method may comprise: determining, by the at least one processor, a muscular activation state of the user, based on the neuromuscular signals; and causing, by the at least one processor, feedback to be provided to the user via the user interface, the feedback comprising any one or any combination of: information on whether the determined muscular activation state may be used to control the XR system, information on whether the determined muscular activation state has a corresponding control signal, information on a control operation corresponding to the determined muscular activation state, and a query to the user to confirm that the XR system is to be controlled to perform an operation corresponding to the determined muscular activation state. The user interface may comprise any one or any combination of: an audio interface, a video interface, a tactile interface, and an electrical stimulation interface.

In another aspect, the method may comprise: receiving, by the at least one computer processor, information from the XR system indicating a current state of the XR system. The neuromuscular signals may be interpreted based on the received information.

In an aspect, the XR system may comprise a plurality of operational modes. The method may comprise: identifying, by the at least one computer processor, a third muscular activation state of the user based on the neuromuscular signals; and changing, by the at least one computer processor based on the third muscular activation state, an operation of the XR system from a first mode to a second mode, the second mode being a mode for controlling operations of the XR system.

In another aspect, the method may comprise: identifying, by the at least one computer processor, a plurality of second muscular activation states of the user based on the neuromuscular signals; and outputting, by the at least one computer processor based on the plurality of second muscular activation states, a plurality of control signals to the XR system to control the operation of the XR system.

In a variation of this aspect, the method may comprise: identifying, by the at least one computer processor, a plurality of third muscular activation states of the user based on the neuromuscular signals; and outputting, based on the plurality of second muscular activation states, or the plurality of third muscular activation states, or both the plurality of the second muscular activation states and the plurality of third muscular activation states, a plurality of control signals to the XR system to control an operation of the XR system.

According to aspects of the technology described herein at least one non-transitory computer-readable storage medium is provided. The at least one storage medium may store code that, when executed by at least one computer processor, causes the at least one computer processor to perform a method for controlling an extended reality (XR) system based on neuromuscular signals. The method may comprise: receiving neuromuscular signals sensed from a user by one or more neuromuscular sensors arranged on one or more wearable devices worn by the user; identifying a first muscular activation state of the user based on the neuromuscular signals; determining, based on the first muscular activation state, an operation of an XR system to be controlled; identifying a second muscular activation state of the user based on the neuromuscular signals; and outputting, based on the second muscular activation state, a control signal to the XR system to control the operation of the XR system.

In an aspect, the XR system may comprise an augmented reality (AR) system.

In another aspect, the XR system may comprise any one or any combination of: an augmented reality (AR) system, a virtual reality (VR) system, and a mixed reality (MR) system.

In an aspect, the one or more neuromuscular sensors may comprise at least one electromyography (EMG) sensor.

In another aspect, the first muscular activation state, or the second muscular activation state, or both the first and second muscular activation states may comprise a static gesture as detected from the user.

In an aspect, the first muscular activation state, or the second muscular activation state, or both the first and second muscular activation states may comprise a dynamic gesture as detected from the user.

In another aspect, the first muscular activation state, or the second muscular activation state, or both the first and second muscular activation states may comprise a sub-muscular activation state as detected from the user.

In an aspect, the first muscular activation state and the second muscular activation state may be a same activation state.

In an aspect, the operation of the XR system to be controlled, which is determined based on the first muscular activation state, comprises an operation of a wake-up mode of the XR system.

In a variation of this aspect, the control signal, which is output by the at least one computer processor based on the second muscular activation state, controls an initialization operation of the XR system.

In another aspect, the control signal may comprise a signal that controls one or both of an attribute and a function of a display device associated with the XR system.

In an aspect, the control signal may comprise a signal that controls one or both of an attribute and a function of an audio device associated with the XR system.

In another aspect, the control signal may comprise a signal that controls a privacy mode or a privacy setting of one or more devices associated with the XR system.

In an aspect, the control signal may comprise a signal that controls a power mode or a power setting of the XR system.

In another aspect, the control signal may comprise a signal that controls one or both of an attribute and a function of a camera device associated with the XR system.

In an aspect, the control signal may comprise a signal that controls a display of content by the XR system.

In another aspect, the control signal may comprise a signal that controls information to be provided by the XR system.

In an aspect, the control signal may comprise a signal that controls communication of information associated with the XR system to a second XR system.

In another aspect, the control signal may comprise a signal that controls a visualization of the user generated by the XR system.

In an aspect, the control signal may comprise a signal that controls a visualization of an object generated by the XR system.

In another aspect, the method may comprises: causing a user interface displayed in an XR environment provided by the XR system to present one or more instructions on how to control the operation of the XR system.

In a variation of this aspect, the one or more instructions include a visual demonstration of how to achieve the first muscular activation state, or the second muscular activation state, or both the first and second muscular activation states.

In another variation of this aspect, the method may comprise: determining a muscular activation state of the user based on the neuromuscular signals; and causing feedback to be provided to the user via the user interface, the feedback comprising any one or any combination of: information on whether the determined muscular activation state may be used to control the XR system, information on whether the determined muscular activation state has a corresponding control signal, information on a control operation corresponding to the determined muscular activation state, and a query to the user to confirm that the XR system is to be controlled to perform an operation corresponding to the determined muscular activation state. The user interface may comprise any one or any combination of: an audio interface, a video interface, a tactile interface, and an electrical stimulation interface.

In another aspect, the method may comprise: receiving information from the XR system indicating a current state of the XR system. The neuromuscular signals may be interpreted based on the received information.

In an aspect, the XR system may comprise a plurality of operational modes. The method may comprise: identifying a third muscular activation state of the user based on the neuromuscular signals; and changing, based on the third muscular activation state, an operation of the XR system from a first mode to a second mode, the second mode being a mode for controlling operations of the XR system.

In another aspect, the method may comprise: identifying a plurality of second muscular activation states of the user based on the neuromuscular signals; and outputting, based on the plurality of second muscular activation states, a plurality of control signals to the XR system to control the operation of the XR system.

In a variation of this aspect, the method may comprise: identifying a plurality of third muscular activation states of the user based on the neuromuscular signals; and outputting, based on the plurality of second muscular activation states, or the plurality of third muscular activation states, or both the plurality of the second muscular activation states and the plurality of third muscular activation states, a plurality of control signals to the XR system to control an operation of the XR system.

According to aspects of the technology described herein, a computerized system for controlling an extended reality (XR) system based on neuromuscular signals is provided. The system may comprise: a plurality of neuromuscular sensors configured to sense a plurality of neuromuscular signals from a user, and at least one computer processor. The plurality of neuromuscular sensors may be arranged on one or more wearable devices worn by the user to sense the plurality of neuromuscular signals. The at least one computer processor may be programmed to: identify a muscular activation state of the user based on the plurality of neuromuscular signals; determine, based on the muscular activation state, an operation of the XR system to be controlled; and output, based on the muscular activation state, a control signal to the XR system to control the operation of the XR system.

According to aspects of the technology described herein, a kit for controlling an extended reality (XR) system is provided. The kit may comprise: a wearable device comprising one or more neuromuscular sensors configured to detect a plurality of neuromuscular signals from a user; and at least one non-transitory computer-readable storage medium storing code that, when executed by at least one computer processor, causes the at least one computer processor to perform a method for controlling an extended reality (XR) system based on neuromuscular signals. The method may comprise: receiving the plurality of neuromuscular signals detected from the user by the one or more neuromuscular sensors; identifying a neuromuscular activation state of the user based on the plurality of neuromuscular signals; determining, based on the identified neuromuscular activation state, an operation of the XR system to be controlled; and outputting a control signal to the XR system to control the operation of the XR system.

In an aspect, the wearable device may comprise a wearable band structured to be worn around a part of the user.

In another aspect, the wearable device may comprise a wearable patch structured to be worn on a part of the user.

It should be appreciated that all combinations of the foregoing concepts and additional concepts discussed in greater detail below (provided such concepts are not mutually inconsistent) are contemplated as being part of the inventive subject matter disclosed herein. In particular, all combinations of claimed subject matter appearing at the end of this disclosure are contemplated as being part of the inventive subject matter disclosed herein.

### BRIEF DESCRIPTION OF DRAWINGS

Various non-limiting embodiments of the technology will be described with reference to the following figures. It should be appreciated that the figures are not necessarily drawn to scale.

FIG. 1 is a schematic diagram of a computer-based system for processing neuromuscular sensor data, such as signals obtained from neuromuscular sensors, in accordance with some embodiments of the technology described herein;

FIG. 2 is a schematic diagram of a distributed computer-based system that integrates an AR system with a neuromuscular activity system, in accordance with some embodiments of the technology described herein;

FIG. 3 is a flowchart of a process for controlling an AR system, in accordance with some embodiments of the technology described herein;

FIG. 4 is a flowchart of a process for controlling an AR system based on one or more muscular activation states of a user, in accordance with some embodiments of the technology described herein;

FIG. 5 illustrates a wristband having EMG sensors arranged circumferentially thereon, in accordance with some embodiments of the technology described herein.

FIG. 6A illustrates a wearable system with sixteen EMG sensors arranged circumferentially around a band configured to be worn around a user's lower arm or wrist, in accordance with some embodiments of the technology described herein;

FIG. 6B is a cross-sectional view through one of the sixteen EMG sensors illustrated in FIG. 6A;

FIGS. 7A and 7B schematically illustrate components of a computer-based system in which some embodiments of the technology described herein are implemented. FIG. 7A illustrates a wearable portion of the computer-based system, and FIG. 7B illustrates a dongle portion connected to a computer, wherein the dongle portion is configured to communicate with the wearable portion.

FIGS. 8A, 8B, 8C, and 8D schematically illustrate patch type wearable systems with sensor electronics incorporated thereon, in accordance with some embodiment of the technology described herein.

### DETAILED DESCRIPTION

The inventors have developed novel techniques for controlling AR systems as well as other types of XR systems, such as VR systems and MR systems. Various embodiments of the technologies presented herein offer certain advantages, including avoiding the use of an undesirable or burdensome physical keyboard or microphone; overcoming issues associated with time-consuming and/or high-latency processing of low-quality images of a user captured by a camera; allowing for capture and detection of subtle, small, or fast movements and/or variations in pressure (e.g., varying amounts of force exerted through a stylus, writing instrument, or finger being pressed against a surface) that can be important for resolving text input; obtaining or collecting and analyzing various sensory information that enhances an identification process and may not be readily obtained by conventional input devices; and allowing for instances where a user's hand is obscured or outside a camera's field of view, e.g., in the user's pocket, or while the user is wearing a glove.

In accordance with some embodiments of the technology described herein, signals sensed by one or more wearable sensors may be used to control an XR system. The inventors have recognized that a number of muscular activation states of a user may be identified from such sensed and recorded signals and/or from information based on or derived from such sensed and recorded signals to enable improved control of the XR system. Neuromuscular signals may be used directly as an input to an XR system (e.g. by using motor-unit action potentials as an input signal) and/or the neuromuscular signals may be processed (including by using an inference model as described herein) for the purpose of determining a movement, a force, and/or a position of a part of the user's body (e.g. fingers, hand, wrist, etc.). Various operations of the XR system may be controlled based on identified muscular activation states. An operation of the XR system may include any aspect of the XR system that the user can control based on sensed and recorded signals from the wearable sensors. The muscular activation states may include, but are not limited to, a static gesture or pose performed by the user, a dynamic gesture or motion performed by the user, a sub-muscular activation state of the user, a muscular tensing or relaxation performed by the user, or any combination of the foregoing. For instance, control of an XR system may include control based on activation of one or more individual motor units, e.g., control based on a detected sub-muscular activation state of the user, such as a sensed tensing of a muscle. Identification of one or more muscular activation state(s) may allow a layered or multi-level approach to controlling operation(s) of the XR system. For instance, at a first layer/level, one muscular activation state may indicate that a mode of the XR system is to be switched from a first mode (e.g., an XR interaction mode) to a second mode (e.g., a control mode for controlling operations of the XR system); at a second layer/level, another muscular activation state may indicate an operation of the XR system that is to be controlled; and at a third layer/level, yet another muscular activation state may indicate how the indicated operation of the XR system is to be controlled. It will be appreciated that any number of muscular activation states and layers may be used without departing from the scope of this disclosure. For example, in some embodiments, one or more muscular activation state(s) may correspond to a concurrent gesture based on activation of one or more motor units, e.g., the user's hand bending at the wrist while pointing the index finger. In some embodiments, one or more muscular activation state(s) may correspond to a sequence of gestures based on activation of one or more motor units, e.g., the user's hand bending at the wrist upwards and then downwards. In some embodiments, a single muscular activation state may both indicate to switch into a control mode and indicate the operation of the XR system that is to be controlled. As will be appreciated, the phrases “sensed and recorded”, “sensed and collected”, “recorded”, “collected”, “obtained”, and the like, when used in conjunction with a sensor signal comprises a signal detected or sensed by the sensor. As will be appreciated, the signal may be sensed and recorded or collected without storage in a nonvolatile memory, or the signal may be sensed and recorded or collected with storage in a local nonvolatile memory or in an external nonvolatile memory. For example, after detection or being sensed, the signal may be stored at the sensor “as-detected” (i.e., raw), or the signal may undergo processing at the sensor prior to storage at the sensor, or the signal may be communicated (e.g., via a Bluetooth technology or the like) to an external device for processing and/or storage, or any combination of the foregoing.

As an example, sensor signals may be sensed and recorded while the user performs a first gesture. The first gesture, which may be identified based on the sensor signals, may indicate that the user wants to control an operation and/or an aspect (e.g., brightness) of a display device associated with an XR system. In response to the XR system detecting the first gesture, a settings screen associated with the display device may be displayed by the XR system. Sensor signals may continue to be sensed and recorded while the user performs a second gesture. Responsive to detecting the second gesture, the XR system may, e.g., select a brightness controller (e.g., a slider control bar) on the settings screen. Sensor signals may continue to be sensed and recorded while the user performs a third gesture or series of gestures that may, e.g., indicate how the brightness is to be controlled. For example, one or more upward swipe gestures may indicate that the user wants to increase the brightness of the display device and detection of the one or more upward swipe gestures may cause the slider control bar to be manipulated accordingly on the settings screen of the XR system.

According to some embodiments, the muscular activation states may be identified, at least in part, from raw (e.g., unprocessed) sensor signals obtained (e.g., sensed and recorded) by one or more of the wearable sensors. In some embodiments, the muscular activation states may be identified, at least in part, from information based on the raw sensor signals (e.g., processed sensor signals), where the raw sensor signals obtained by one or more of the wearable sensors are processed to perform, e.g., amplification, filtering, rectification, and/or other form of signal processing, examples of which are described in more detail below. In some embodiments, the muscular activation states may be identified, at least in part, from an output of a trained inference model that receives the sensor signals (raw or processed versions of the sensor signals) as input.

In contrast to some conventional techniques that may be used for controlling XR systems, muscular activation states, as determined based on sensor signals in accordance with one or more of the techniques described herein, may be used to control various aspects and/or operations of the XR system, thereby reducing the need to rely on cumbersome and inefficient input devices, as discussed above. For example, sensor data (e.g., signals obtained from neuromuscular sensors or data derived from such signals) may be recorded and muscular activation states may be identified from the recorded sensor data without the user having to carry a controller and/or other input device, and without having the user remember complicated button or key manipulation sequences. Also, the identification of the muscular activation states (e.g., poses, gestures, etc.) from the recorded sensor data can be performed relatively fast, thereby reducing the response times and latency associated with controlling the XR system. Furthermore, some embodiments of the technology described herein enable user-customizable control of the XR system, such that each user may define a control scheme for controlling one or more aspects and/or operations of the XR system specific to that user.

Signals sensed and recorded by wearable sensors placed at locations on a user's body may be provided as input to an inference model trained to generate spatial and/or force information for rigid segments of a multi-segment articulated rigid-body model of a human body. The spatial information may include, for example, position information of one or more segments, orientation information of one or more segments, joint angles between segments, and the like. Based on the input, and as a result of training, the inference model may implicitly represent inferred motion of the articulated rigid body under defined movement constraints. The trained inference model may output data useable for applications such as applications for rendering a representation of the user's body in an XR environment, in which the user may interact with physical and/or virtual objects, and/or applications for monitoring the user's movements as the user performs a physical activity to assess, for example, whether the user is performing the physical activity in a desired manner. As will be appreciated, the output data from the trained inference model may be used for applications other than those specifically identified herein.

For instance, movement data obtained by a single movement sensor positioned on a user (e.g., on a user's wrist or arm) may be provided as input data to a trained inference model. Corresponding output data generated by the trained inference model may be used to determine spatial information for one or more segments of a multi-segment articulated rigid-body model for the user. For example, the output data may be used to determine the position and/or the orientation of one or more segments in the multi-segment articulated rigid body model. In another example, the output data may be used to determine angles between connected segments in the multi-segment articulated rigid-body model.

Different types of sensors may be used to provide input data to a trained inference model, as discussed below.

As described herein, in some embodiments of the present technology, various muscular activation states may be identified directly from sensor data. In other embodiments, handstates, gestures, postures, and the like (which may be referred to herein individually or collectively as muscular activation states) may be identified based, at least in part, on the output of a trained inference model. In some embodiments, the trained inference model may output motor-unit or muscle activations and/or position, orientation, and/or force estimates for segments of a computer-generated musculoskeletal model. In one example, all or portions of the human musculoskeletal system can be modeled as a multi-segment articulated rigid body system, with joints forming the interfaces between the different segments, and with joint angles defining the spatial relationships between connected segments in the model.

As used herein, the term “gestures” may refer to a static or dynamic configuration of one or more body parts including a position of the one or more body parts and forces associated with the configuration. For example, gestures may include discrete gestures, such as placing or pressing the palm of a hand down on a solid surface or grasping a ball, continuous gestures, such as waving a finger back and forth, grasping and throwing a ball, or a combination of discrete and continuous gestures. Gestures may include covert gestures that may be imperceptible to another person, such as slightly tensing a joint by co-contracting opposing muscles or using sub-muscular activations. In training an inference model, gestures may be defined using an application configured to prompt a user to perform the gestures or, alternatively, gestures may be arbitrarily defined by a user. The gestures performed by the user may include symbolic gestures (e.g., gestures mapped to other gestures, interactions, or commands, for example, based on a gesture vocabulary that specifies the mapping). In some cases, hand and arm gestures may be symbolic and used to communicate according to cultural standards.

In some embodiments of the technology described herein, sensor signals may be used to predict information about a position and/or a movement of a portion of a user's arm and/or the user's hand, which may be represented as a multi-segment articulated rigid-body system with joints connecting the multiple segments of the rigid-body system. For example, in the case of a hand movement, signals sensed and recorded by wearable neuromuscular sensors placed at locations on the user's body (e.g., the user's arm and/or wrist) may be provided as input to an inference model trained to predict estimates of the position (e.g., absolute position, relative position, orientation) and the force(s) associated with a plurality of rigid segments in a computer-based musculoskeletal representation associated with a hand when the user performs one or more hand movements. The combination of position information and force information associated with segments of a musculoskeletal representation associated with a hand may be referred to herein as a “handstate” of the musculoskeletal representation. As a user performs different movements, a trained inference model may interpret neuromuscular signals sensed and recorded by the wearable neuromuscular sensors into position and force estimates (handstate information) that are used to update the musculoskeletal representation. Because the neuromuscular signals may be continuously sensed and recorded, the musculoskeletal representation may be updated in real time and a visual representation of a hand (e.g., within an XR environment) may be rendered based on current estimates of the handstate. As will be appreciated, an estimate of a user's handstate may be used to determine a gesture being performed by the user and/or to predict a gesture that the user will perform.

Constraints on the movement at a joint are governed by the type of joint connecting the segments and the biological structures (e.g., muscles, tendons, ligaments) that may restrict the range of movement at the joint. For example, a shoulder joint connecting the upper arm to a torso of a body of a human subject, and a hip joint connecting an upper leg to the torso, are ball and socket joints that permit extension and flexion movements as well as rotational movements. By contrast, an elbow joint connecting the upper arm and a lower arm (or forearm), and a knee joint connecting the upper leg and a lower leg of the human subject, allow for a more limited range of motion. In this example, a multi-segment articulated rigid body system may be used to model portions of the human musculoskeletal system. However, it should be appreciated that although some segments of the human musculoskeletal system (e.g., the forearm) may be approximated as a rigid body in the articulated rigid body system, such segments may each include multiple rigid structures (e.g., the forearm may include ulna and radius bones), which may enable more complex movements within the segment that is not explicitly considered by the rigid body model. Accordingly, a model of an articulated rigid body system for use with some embodiments of the technology described herein may include segments that represent a combination of body parts that are not strictly rigid bodies. It will be appreciated that physical models other than the multi-segment articulated rigid body system may be used to model portions of the human musculoskeletal system without departing from the scope of this disclosure.

Continuing with the example above, in kinematics, rigid bodies are objects that exhibit various attributes of motion (e.g., position, orientation, angular velocity, acceleration). Knowing the motion attributes of one segment of a rigid body enables the motion attributes for other segments of the rigid body to be determined based on constraints in how the segments are connected. For example, the hand may be modeled as a multi-segment articulated body, with joints in the wrist and each finger forming interfaces between the multiple segments in the model. In some embodiments, movements of the segments in the rigid body model can be simulated as an articulated rigid body system in which position (e.g., actual position, relative position, or orientation) information of a segment relative to other segments in the model are predicted using a trained inference model, as described in more detail below.

The portion of the human body approximated by a musculoskeletal representation as described herein as one non-limiting example, is a hand or a combination of a hand with one or more arm segments. The information used to describe a current state of the positional relationships between segments, force relationships for individual segments or combinations of segments, and muscle and motor-unit activation relationships between segments, in the musculoskeletal representation is referred to herein as the handstate of the musculoskeletal representation (see discussion above). It should be appreciated, however, that the techniques described herein are also applicable to musculoskeletal representations of portions of the body other than the hand including, but not limited to, an arm, a leg, a foot, a torso, a neck, or any combination of the foregoing.

In addition to spatial (e.g., position and/or orientation) information, some embodiments enable a prediction of force information associated with one or more segments of the musculoskeletal representation. For example, linear forces or rotational (torque) forces exerted by one or more segments may be estimated. Examples of linear forces include, but are not limited to, the force of a finger or hand pressing on a solid object such as a table, and a force exerted when two segments (e.g., two fingers) are pinched together. Examples of rotational forces include, but are not limited to, rotational forces created when a segment, such as in a wrist or a finger, is twisted or flexed relative to another segment. In some embodiments, the force information determined as a portion of a current handstate estimate includes one or more of: pinching force information, grasping force information, and information about co-contraction forces between muscles represented by the musculoskeletal representation.

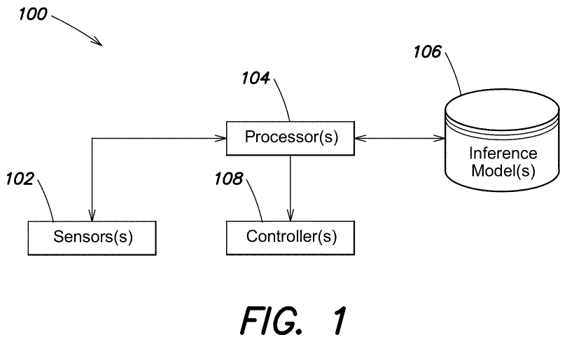

Turning now to the figures, FIG. 1 schematically illustrates a system 100, for example, a neuromuscular activity system, in accordance with some embodiments of the technology described herein. The system 100 includes one or more sensor(s) 102 (e.g., one or more neuromuscular sensor(s)) configured to sense and record signals arising from neuromuscular activity in skeletal muscles of a human body. The term “neuromuscular activity” as used herein refers to neural activation of spinal motor neurons or units that innervate a muscle, muscle activation, muscle contraction, or any combination of the neural activation, muscle activation, and muscle contraction. Neuromuscular sensors may include one or more electromyography (EMG) sensors, one or more mechanomyography (MMG) sensors, one or more sonomyography (SMG) sensors, a combination of two or more types of EMG sensors, MMG sensors, and SMG sensors, and/or one or more sensors of any suitable type able to detect neuromuscular signals. In some embodiments, the plurality of neuromuscular sensors may be arranged relative to the human body and used to sense muscular activity related to a movement of the part of the body controlled by muscles from which the muscular activity is sensed by the one or more neuromuscular sensor(s). Spatial information (e.g., position and/or orientation information) and force information describing the movement may be predicted based on the sensed neuromuscular signals as the user moves over time. In some embodiments, the one or more neuromuscular sensor(s) may sense muscular activity related to movement caused by external objects, for example, movement of a hand being pushed by an external object.

As the tension of a muscle increases during performance of a motor task, the firing rates of active neurons increases and additional neurons may become active, which is a process that may be referred to as motor-unit recruitment. The pattern by which neurons become active and increase their firing rate is stereotyped, such that expected motor-unit recruitment patterns may define an activity manifold associated with standard or normal movement. Some embodiments may sense and record activation of a single motor unit or a group of motor units that are “off-manifold,” in that the pattern of motor-unit activation is different than an expected or typical motor-unit recruitment pattern. Such off-manifold activation may be referred to herein as “sub-muscular activation” or “activation of a sub-muscular structure,” where a sub-muscular structure refers to the single motor unit or the group of motor units associated with the off-manifold activation. Examples of off-manifold motor-unit recruitment patterns include, but are not limited to, selectively activating a higher-threshold motor unit without activating a lower-threshold motor unit that would normally be activated earlier in the recruitment order and modulating the firing rate of a motor unit across a substantial range without modulating the activity of other neurons that would normally be co-modulated in typical motor-unit recruitment patterns. In some embodiments, the one or more neuromuscular sensors may be arranged relative to the human body and used to sense sub-muscular activation without observable movement, i.e., without a corresponding movement of the body that can be readily observed. Sub-muscular activation may be used, at least in part, to control an XR system in accordance with some embodiments of the technology described herein.

The one or more sensor(s) 102 may include one or more auxiliary sensor(s), such as one or more Inertial Measurement Unit(s), or IMU(s), which measure a combination of physical aspects of motion, using, for example, an accelerometer, a gyroscope, a magnetometer, or any combination of one or more accelerometers, gyroscopes, and magnetometers. In some embodiments, one or more IMU(s) may be used to sense information about the movement of the part of the body on which the IMU(s) is or are attached, and information derived from the sensed data (e.g., position and/or orientation information) may be tracked as the user moves over time. For example, one or more IMU(s) may be used to track movements of portions (e.g., arms, legs) of a user's body proximal to the user's torso relative to the IMU(s) as the user moves over time.

In embodiments that include at least one IMU and one or more neuromuscular sensor(s), the IMU(s) and the neuromuscular sensor(s) may be arranged to detect movement of different parts of a human body. For example, the IMU(s) may be arranged to detect movements of one or more body segments proximal to the torso (e.g., movements of an upper arm), whereas the neuromuscular sensors may be arranged to detect movements of one or more body segments distal to the torso (e.g., movements of a lower arm (forearm) or a wrist). It should be appreciated, however, that the sensors (i.e., the IMU(s) and the neuromuscular sensors) may be arranged in any suitable way, and embodiments of the technology described herein are not limited based on the particular sensor arrangement. For example, in some embodiments, at least one IMU and a plurality of neuromuscular sensors may be co-located on a body segment to track movements of the body segment using different types of measurements. In one implementation, an IMU and a plurality of EMG sensors may be arranged on a wearable device structured to be worn around the lower arm or the wrist of a user. In such an arrangement, the IMU may be configured to track, over time, movement information (e.g., positioning and/or orientation) associated with one or more arm segments, to determine, for example, whether the user has raised or lowered his/her arm, whereas the EMG sensors may be configured to determine movement information associated with wrist and/or hand segments to determine, for example, whether the user has an open or closed hand configuration, or to determine sub-muscular information associated with activation of sub-muscular structures in muscles of the wrist and/or the hand.

Some or all of the sensor(s) 102 may each include one or more sensing components configured to sense information about a user. In the case of IMUs, the sensing component(s) of an IMU may include one or more: accelerometer, gyroscope, magnetometer, or any combination thereof, to measure or sense characteristics of body motion, examples of which include, but are not limited to, acceleration, angular velocity, and a magnetic field around the body during the body motion. In the case of neuromuscular sensors, the sensing component(s) may include, but are not limited to, one or more: electrodes that detect electric potentials on the surface of the body (e.g., for EMG sensors), vibration sensors that measure skin surface vibrations (e.g., for MMG sensors), acoustic sensing components that measure ultrasound signals (e.g., for SMG sensors) arising from muscle activity, or any combination thereof. Optionally, the sensor(s) 102 may include any one or any combination of: a thermal sensor that measures the user's skin temperature (e.g., a thermistor); a cardio sensor that measure's the user's pulse, heart rate, a moisture sensor that measures the user's state of perspiration, and the like.

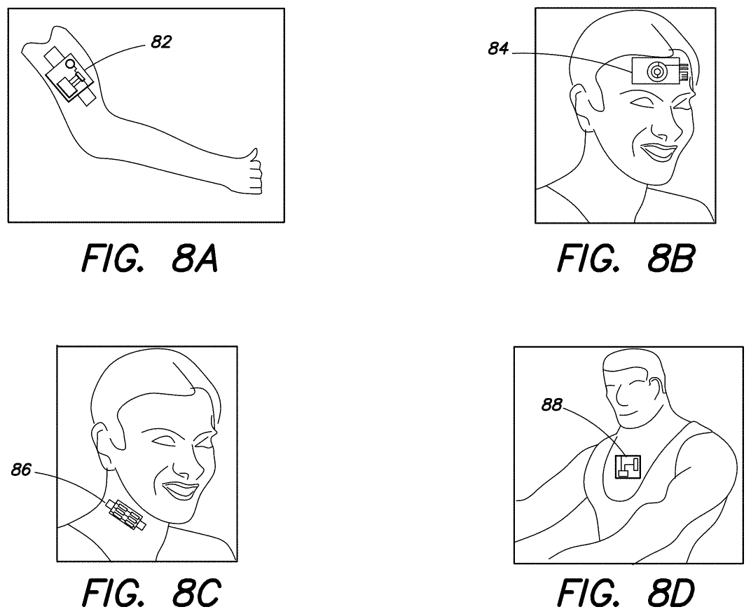

In some embodiments, the one or more sensor(s) 102 may comprise a plurality of sensors 102, and at least some of the plurality of sensors 102 may be arranged as a portion of a wearable device structured to be worn on or around a part of a user's body. For example, in one non-limiting example, an IMU and a plurality of neuromuscular sensors may be arranged circumferentially on an adjustable and/or elastic band, such as a wristband or an armband structured to be worn around a user's wrist or arm, as described in more detail below. In some embodiments, multiple wearable devices, each having one or more IMUs and/or neuromuscular sensors included thereon may be used to generate control information based on activation from sub-muscular structures and/or based on movement that involves multiple parts of the body. Alternatively, at least some of the sensors 102 may be arranged on a wearable patch structured to be affixed to a portion of the user's body. FIGS. 8A-8D show various types of wearable patches. FIG. 8A shows a wearable patch 82 in which circuitry for an electronic sensor may be printed on a flexible substrate that is structured to adhere to an arm, e.g., near a vein to sense blood flow in the user or near a muscle to sense neuromuscular signals. The wearable patch 82 may be an RFID-type patch, which may transmit sensed information wirelessly upon interrogation by an external device. FIG. 8B shows a wearable patch 84 in which an electronic sensor may be incorporated on a substrate that is structured to be worn on the user's forehead, e.g., to measure moisture from perspiration. The wearable patch 84 may include circuitry for wireless communication, or may include a connector structured to be connectable to a cable, e.g., a cable attached to a helmet, a heads-mounted display, or another external device. The wearable patch 84 may be structured to adhere to the user's forehead or to be held against the user's forehead by, e.g., a headband, skullcap, or the like. FIG. 8C shows a wearable patch 86 in which circuitry for an electronic sensor may be printed on a substrate that is structured to adhere to the user's neck, e.g., near the user's carotid artery to sense flood flow to the user's brain. The wearable patch 86 may be an RFID-type patch or may include a connector structured to connect to external electronics. FIG. 8D shows a wearable patch 88 in which an electronic sensor may be incorporated on a substrate that is structured to be worn near the user's heart, e.g., to measure the user's heartrate or to measure blood flow to/from the user's heart. As will be appreciated, wireless communication is not limited to RFID technology, and other communication technologies may be employed. Also, as will be appreciated, the sensors 102 may be incorporated on other types of wearable patches that may be structured differently from those shown in FIGS. 8A-8D, and any of the wearable patch sensors described herein may include one or more neuromuscular sensors.

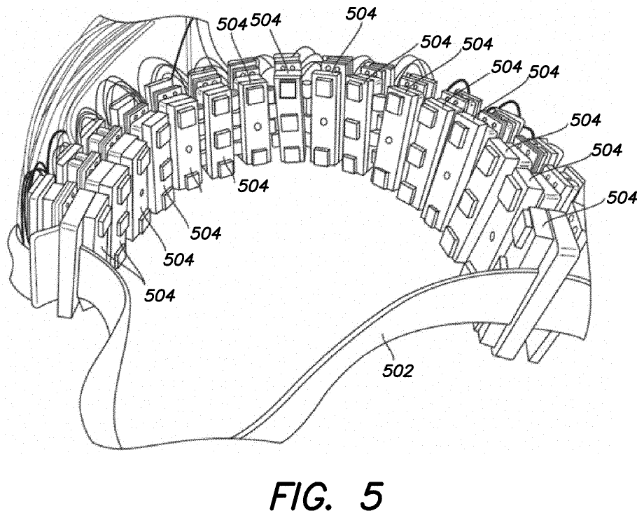

In one implementation, the sensors 102 may include sixteen neuromuscular sensors arranged circumferentially around a band (e.g., an elastic band) structured to be worn around a user's lower arm (e.g., encircling the user's forearm). For example, FIG. 5 shows an embodiment of a wearable system in which neuromuscular sensors 504 (e.g., EMG sensors) are arranged circumferentially around an elastic band 502. It should be appreciated that any suitable number of neuromuscular sensors may be used and the number and arrangement of neuromuscular sensors used may depend on the particular application for which the wearable system is used. For example, a wearable armband or wristband may be used to generate control information for controlling an XR system, controlling a robot, controlling a vehicle, scrolling through text, controlling a virtual avatar, or any other suitable control task. In some embodiments, the elastic band 502 may also include one or more IMUs (not shown), configured to sense and record movement information, as discussed above.

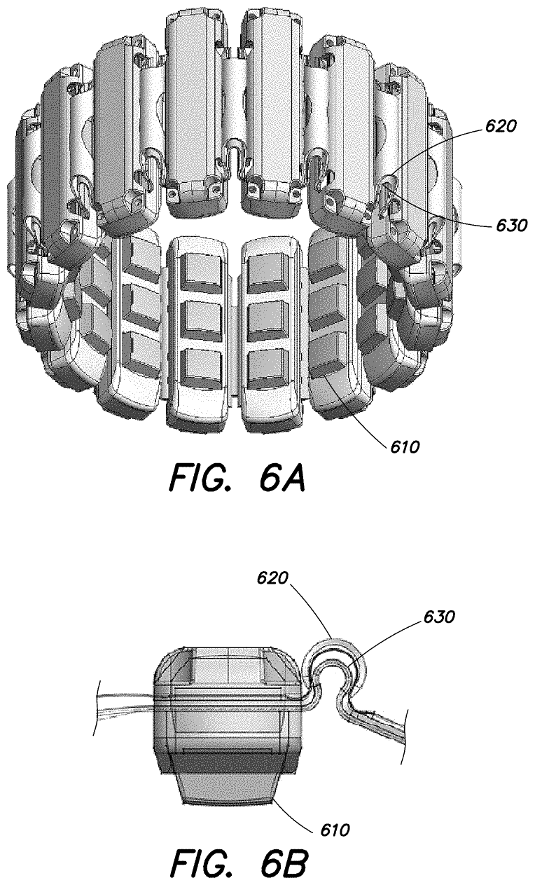

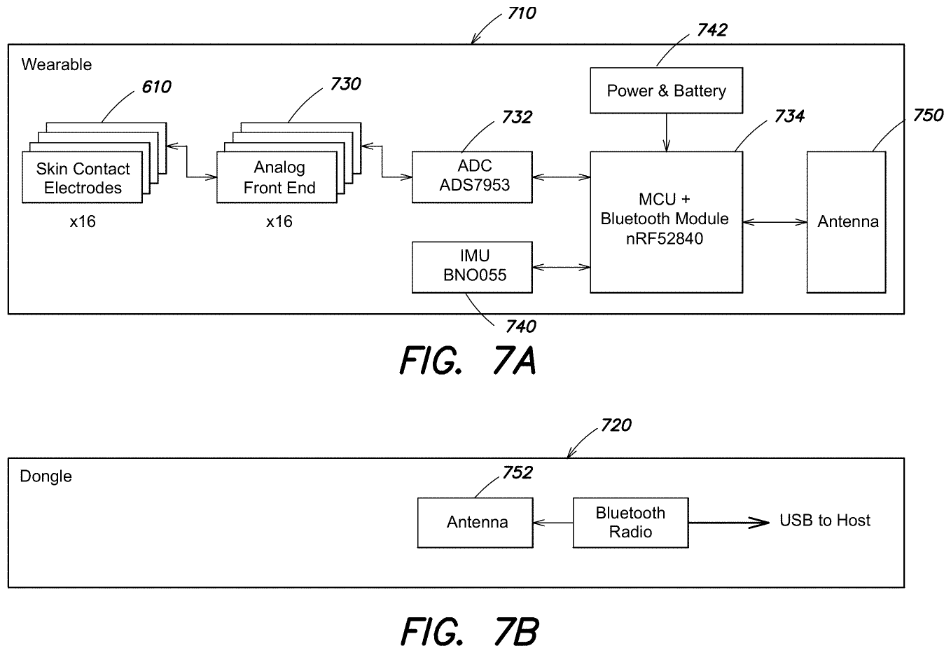

FIGS. 6A-6B and 7A-7B show other embodiments of a wearable system of the present technology. In particular, FIG. 6A illustrates a wearable system with a plurality of sensors 610 arranged circumferentially around an elastic band 620 structured to be worn around a user's lower arm or wrist. The sensors 610 may be neuromuscular sensors (e.g., EMG sensors). As shown, there may be sixteen sensors 610 arranged circumferentially around the elastic band 620 at a regular spacing. It should be appreciated that any suitable number of sensors 610 may be used, and the spacing need not be regular. The number and arrangement of the sensors 610 may depend on the particular application for which the wearable system is used. For instance, the number and arrangement of the sensors 610 may differ when the wearable system is to be worn on a wrist in comparison with a thigh. A wearable system (e.g., armband, wristband, thighband, etc.) can be used to generate control information for controlling an XR system, controlling a robot, controlling a vehicle, scrolling through text, controlling a virtual avatar, and/or performing any other suitable control task.

In some embodiments, the sensors 610 may include only a set of neuromuscular sensors (e.g., EMG sensors). In other embodiments, the sensors 610 may include a set of neuromuscular sensors and at least one auxiliary device. The auxiliary device(s) may be configured to continuously sense and record one or a plurality of auxiliary signal(s). Examples of auxiliary devices include, but are not limited to, IMUs, microphones, imaging devices (e.g., cameras), radiation-based sensors for use with a radiation-generation device (e.g., a laser-scanning device), heart-rate monitors, and other types of devices, which may capture a user's condition or other characteristics of the user. As shown in FIG. 6A, the sensors 610 may be coupled together using flexible electronics 630 incorporated into the wearable system. FIG. 6B illustrates a cross-sectional view through one of the sensors 610 of the wearable system shown in FIG. 6A.

In some embodiments, the output(s) of one or more of sensing component(s) of the sensors 610 can be optionally processed using hardware signal-processing circuitry (e.g., to perform amplification, filtering, and/or rectification). In other embodiments, at least some signal processing of the output(s) of the sensing component(s) can be performed using software. Thus, signal processing of signals sampled by the sensors 610 can be performed by hardware or by software, or by any suitable combination of hardware and software, as aspects of the technology described herein are not limited in this respect. A non-limiting example of a signal-processing procedure used to process recorded data from the sensors 610 is discussed in more detail below in connection with FIGS. 7A and 7B.

FIGS. 7A and 7B illustrate a schematic diagram with internal components of a wearable system with sixteen sensors (e.g., EMG sensors), in accordance with some embodiments of the technology described herein. As shown, the wearable system includes a wearable portion 710 (FIG. 7A) and a dongle portion 720 (FIG. 7B). Although not illustrated, the dongle portion 720 is in communication with the wearable portion 710 (e.g., via Bluetooth or another suitable short range wireless communication technology). As shown in FIG. 7A, the wearable portion 710 includes the sensors 610, examples of which are described above in connection with FIGS. 6A and 6B. The sensors 610 provide output (e.g., signals) to an analog front end 730, which performs analog processing (e.g., noise reduction, filtering, etc.) on the signals. Processed analog signals produced by the analog front end 730 are then provided to an analog-to-digital converter 732, which converts the processed analog signals to digital signals that can be processed by one or more computer processors. An example of a computer processor that may be used in accordance with some embodiments is a microcontroller (MCU) 734. As shown in FIG. 7A, the MCU 734 may also receive inputs from other sensors (e.g., an IMU 740) and from a power and battery module 742. As will be appreciated, the MCU 734 may receive data from other devices not specifically shown. A processing output by the MCU 734 may be provided to an antenna 750 for transmission to the dongle portion 720, shown in FIG. 7B.

The dongle portion 720 includes an antenna 752 that communicates with the antenna 750 of the wearable portion 710. Communication between the antennas 750 and 752 may occur using any suitable wireless technology and protocol, non-limiting examples of which include radiofrequency signaling and Bluetooth. As shown, the signals received by the antenna 752 of the dongle portion 720 may be provided to a host computer for further processing, for display, and/or for effecting control of a particular physical or virtual object or objects (e.g., to perform a control operation in an AR or VR environment)

Although the examples provided with reference to FIGS. 6A, 6B, 7A, and 7B are discussed in the context of interfaces with EMG sensors, it is to be understood that the wearable systems described herein can also be implemented with other types of sensors, including, but not limited to, mechanomyography (MMG) sensors, sonomyography (SMG) sensors, and electrical impedance tomography (EIT) sensors.

Returning to FIG. 1, in some embodiments, sensor data sensed and recorded by the sensor(s) 102 may be optionally processed to compute additional derived measurements, which may then be provided as input to an inference model, as described in more detail below. For example, signals from an IMU may be processed to derive an orientation signal that specifies the orientation of a segment of a rigid body over time. The sensor(s) 102 may implement signal processing using components integrated with the sensing components of the sensor(s) 102, or at least a portion of the signal processing may be performed by one or more components in communication with, but not directly integrated with the sensing components of the sensor(s) 102.

The system 100 also includes one or more computer processor(s) 104 programmed to communicate with the sensor(s) 102. For example, signals sensed and recorded by one or more of the sensor(s) 102 may be output from the sensor(s) 102 and provided to the processor(s) 104, which may be programmed to execute one or more machine learning algorithms to process the signals output by the sensor(s) 102. The algorithm(s) may process the signals to train (or retrain) one or more inference model(s) 106, and the trained (or retrained) inference model(s) 106 may be stored for later use in generating control signals and controlling an XR system, as described in more detail below. As will be appreciated, in some embodiments, the inference model(s) 106 may include at least one statistical model.

In some embodiments, the inference model(s) 106 may include a neural network and, for example, may be a recurrent neural network. In some embodiments, the recurrent neural network may be a long short-term memory (LSTM) neural network. It should be appreciated, however, that the recurrent neural network is not limited to being an LSTM neural network and may have any other suitable architecture. For example, in some embodiments, the recurrent neural network may be any one or any combination of: a fully recurrent neural network, a gated recurrent neural network, a recursive neural network, a Hopfield neural network, an associative memory neural network, an Elman neural network, a Jordan neural network, an echo state neural network, and a second-order recurrent neural network, and/or any other suitable type of recurrent neural network. In other embodiments, neural networks that are not recurrent neural networks may be used. For example, deep neural networks, convolutional neural networks, and/or feedforward neural networks, may be used.

In some embodiments, the inference model(s) 106 may produce one or more discrete outputs. Discrete outputs (e.g., discrete classifications) may be used, for example, when a desired output is to know whether a particular pattern of activation (including individual neural spiking events) is currently being performed by a user. For example, the inference model(s) 106 may be trained to estimate whether the user is activating a particular motor unit, activating a particular motor unit with a particular timing, activating a particular motor unit with a particular firing pattern, or activating a particular combination of motor units. On a shorter timescale, a discrete classification may be used in some embodiments to estimate whether a particular motor unit fired an action potential within a given amount of time. In such a scenario, these estimates may then be accumulated to obtain an estimated firing rate for that motor unit.

In embodiments in which an inference model is implemented as a neural network configured to output a discrete output, the neural network may include an output layer that is a softmax layer, such that outputs of the softmax layer add up to one and may be interpreted as probabilities. For instance, the outputs of the softmax layer may be a set of values corresponding to a respective set of control signals, with each value indicating a probability that the user wants to perform a particular control action. As one non-limiting example, the outputs of the softmax layer may be a set of three probabilities (e.g., 0.92, 0.05, and 0.03) indicating the respective probabilities that a detected pattern of activity is one of three known patterns.

It should be appreciated that when the inference model is a neural network configured to output a discrete output (e.g., a discrete signal), the neural network is not required to produce outputs that add up to one. For example, for some embodiments, instead of a softmax layer, the output layer of the neural network may be a sigmoid layer, which does not restrict the outputs to probabilities that add up to one). In such embodiments, the neural network may be trained with a sigmoid cross-entropy cost. Such an implementation may be advantageous in cases where multiple different control actions may occur within a threshold amount of time and it is not important to distinguish an order in which these control actions occur (e.g., a user may activate two patterns of neural activity within the threshold amount of time). In some embodiments, any other suitable non-probabilistic multi-class classifier may be used, as aspects of the technology described herein are not limited in this respect.

In some embodiments, an output of the inference model(s) 106 may be a continuous signal rather than a discrete signal. For example, the model(s) 106 may output an estimate of a firing rate of each motor unit, or the model(s) 106 may output a time-series electrical signal corresponding to each motor unit or sub-muscular structure.

It should be appreciated that aspects of the technology described herein are not limited to using neural networks, as other types of inference models may be employed in some embodiments. For example, in some embodiments, the inference model(s) 106 may comprise a hidden Markov model (HMM), a switching HMM in which switching allows for toggling among different dynamic systems, dynamic Bayesian networks, and/or any other suitable graphical model having a temporal component. Any such inference model may be trained using sensor signals.

As another example, in some embodiments, the inference model(s) 106 may include a classifier that takes, as input, features derived from the recorded sensor signals. In such embodiments, the classifier may be trained using features extracted from the sensor signals. The classifier may be, e.g., a support vector machine, a Gaussian mixture model, a regression based classifier, a decision tree classifier, a Bayesian classifier, and/or any other suitable classifier, as aspects of the technology described herein are not limited in this respect. Input features to be provided to the classifier may be derived from the sensor signals in any suitable way. For example, the sensor signals may be analyzed as time-series data using wavelet analysis techniques (e.g., continuous wavelet transform, discrete-time wavelet transform, etc.), Fourier-analytic techniques (e.g., short-time Fourier transform, Fourier transform, etc.), and/or any other suitable type of time-frequency analysis technique. As one non-limiting example, the sensor signals may be transformed using a wavelet transform and the resulting wavelet coefficients may be provided as inputs to the classifier.

In some embodiments, values for parameters of the inference model(s) 106 may be estimated from training data. For example, when the inference model(s) 106 includes a neural network, parameters of the neural network (e.g., weights) may be estimated from the training data. In some embodiments, parameters of the inference model(s) 106 may be estimated using gradient descent, stochastic gradient descent, and/or any other suitable iterative optimization technique. In embodiments where the inference model(s) 106 includes a recurrent neural network (e.g., an LSTM), the inference model(s) 106 may be trained using stochastic gradient descent and backpropagation through time. The training may employ a cross-entropy loss function and/or any other suitable loss function, as aspects of the technology described herein are not limited in this respect.

The system 100 also may optionally include one or more controller(s) 108. For example, the controller(s) 108 may include a display controller configured to display a visual representation (e.g., a representation of a hand). As discussed in more detail below, the one or more computer processor(s) 104 may implement one or more trained inference models that receive, as input, signals sensed and recorded by the sensors 102 and that provide, as output, information (e.g., predicted handstate information) that may be used to generate control signals and control an XR system.

The system 100 also may optionally include a user interface (not shown).

Feedback determined based on the signals sensed and recorded by the sensor(s) 102 and processed by the processor(s) 104 may be provided via the user interface to facilitate a user's understanding of how the system 100 is interpreting the user's intended activation. For example, the feedback may comprise any one or any combination of: information on whether the determined muscular activation state may be used to control the XR system; information on whether the determined muscular activation state has a corresponding control signal; information on a control operation corresponding to the determined muscular activation state; and a query to the user to confirm that the XR system is to be controlled to perform an operation corresponding to the determined muscular activation state. The user interface may be implemented in any suitable way, including, but not limited to, an audio interface, a video interface, a tactile interface, an electrical stimulation interface, or any combination of the foregoing. For instance, a detected neuromuscular activation state may correspond to exiting an XR environment of the XR system, and the query may ask the user (e.g., audibly and/or via a displayed message, etc.) to confirm that the XR environment is to be exited by making a first with the user's right hand or by saying “yes exit”.

In some embodiments, a computer application that simulates an XR environment may be instructed to provide a visual representation by displaying a visual character, such as an avatar (e.g., via the controller(s) 108). Positioning, movement, and/or forces applied by portions of the visual character within the virtual reality environment may be displayed based on an output of the trained inference model(s) 106. The visual representation may be dynamically updated as continuous signals are sensed and recorded by the sensor(s) 102 and processed by the trained inference model(s) 106 to provide a computer-generated visual representation of the character's movement that is updated in real-time.

Information generated in either system (XR camera inputs, sensor inputs) can be used to improve user experience, accuracy, feedback, inference models, calibration functions, and other aspects in the overall system. To this end, in an XR environment for example, the system 100 may include an XR system that includes one or more processors, a camera, and a display (e.g., via XR glasses or other viewing device and/or another user interface) that provides XR information within a view of the user. The system 100 may also include system elements that couple the XR system with a computer-based system that generates the musculoskeletal representation based on sensor data. For example, the systems may be coupled via a special-purpose or other type of computer system that receives inputs from the XR system and generates the computer-based musculoskeletal representation. Such a system may include a gaming system, robotic control system, personal computer, or other system that is capable of interpreting XR and musculoskeletal information. The XR system and the system that generates the computer-based musculoskeletal representation may also be programmed to communicate directly. Such information may be communicated using any number of interfaces, protocols, and/or media.

As discussed above, some embodiments are directed to using one or more inference model(s) for predicting musculoskeletal information based on signals sensed and recorded by wearable sensors (i.e., sensors of a wearable system or device). As discussed briefly above in the example where portions of the human musculoskeletal system can be modeled as a multi-segment articulated rigid-body system, the types of joints between segments in a multi-segment articulated rigid-body model may serve as constraints to constrain movement of the rigid body. Additionally, different human individuals may move in characteristic ways when performing a task that can be captured in statistical patterns that may be generally applicable to individual user behavior. At least some of these constraints on human body movement may be explicitly incorporated into inference models used for prediction of user movement, in accordance with some embodiments. Additionally or alternatively, the constraints may be learned by the inference models though training based on sensor data, as discussed briefly above.

As discussed above, some embodiments are directed to using an inference model for predicting handstate information to enable generation of a computer-based musculoskeletal representation and/or a real-time update of a computer-based musculoskeletal representation. The inference model may be used to predict the handstate information based on IMU signals, neuromuscular signals (e.g., EMG, MMG, and/or SMG signals), external device or auxiliary signals (e.g., camera or laser-scanning signals), or a combination of IMU signals, neuromuscular signals, and external device or auxiliary signals detected as a user performs one or more movements. For instance, as discussed above, a camera associated with an XR system may be used to capture data of an actual position of a human subject of the computer-based musculoskeletal representation, and such actual-position information may be used to improve the accuracy of the representation. Further, outputs of the inference model(s) may be used to generate a visual representation of the computer-based musculoskeletal representation in an XR environment. For example, a visual representation of muscle groups firing, force being applied, text being entered via movement, or other information produced by the computer-based musculoskeletal representation may be rendered in a visual display of an AR system. In some embodiments, other input/output devices (e.g., auditory inputs/outputs, haptic devices, etc.) may be used to further improve the accuracy of the overall system and/or to improve user experience.

Some embodiments of the technology described herein are directed to using an inference model, at least in part, to map muscular-activation state information, which is information identified from neuromuscular signals sensed and recorded by neuromuscular sensors, to control signals. The inference model may receive as input IMU signals, neuromuscular signals (e.g., EMG, MMG, and/or SMG signals), external device signals (e.g., camera or laser-scanning signals), or a combination of IMU signals, neuromuscular signals, and external device or auxiliary signals detected as a user performs one or more sub-muscular activations, one or more movements, and/or one or more gestures. The inference model may be used to predict control information without the user having to make perceptible movements.

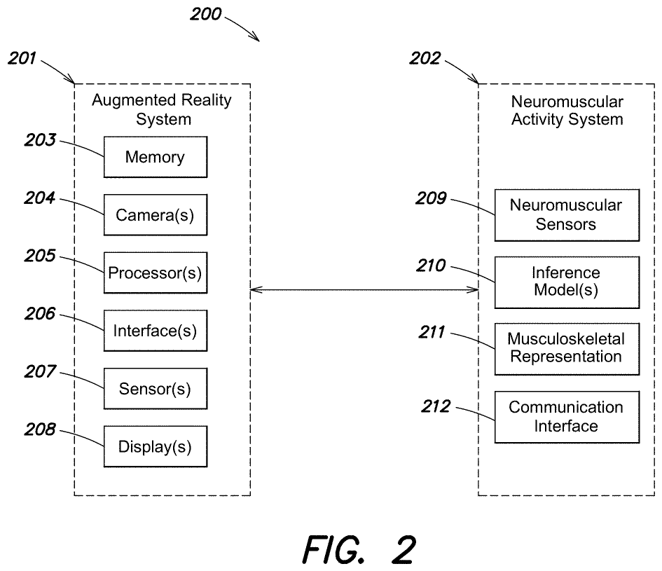

FIG. 2 illustrates a schematic diagram of an AR-based system 200, which may be a distributed computer-based system that integrates an AR system 201 with a neuromuscular activity system 202. The neuromuscular activity system 202 is similar to the system 100 described above with respect to FIG. 1.

Generally, an AR system 201 may take the form of a pair of goggles or glasses or eyewear, or other type of display device that shows display elements to a user that may be superimposed on the user's “reality.” This reality in some cases could be the user's view of the environment (e.g., as viewed through the user's eyes), or a captured version (e.g., by camera(s)) of the user's view of the environment. In some embodiments, the AR system 201 may include one or more cameras (e.g., camera(s) 204), which may be mounted within a device worn by the user, that captures one or more views experienced by the user in the user's environment. The system 201 may have one or more processor(s) 205 operating within the device worn by the user and/or within a peripheral device or computer system, and such processor(s) 205 may be capable of transmitting and receiving video information and other types of data (e.g., sensor data).

The AR system 201 may also include one or more sensor(s) 207, such as microphones, GPS elements, accelerometers, infrared detectors, haptic feedback elements, or any other type of sensor, or any combination thereof. In some embodiments, the AR system 201 may be an audio-based or auditory AR system and the one or more sensor(s) 207 may also include one or more headphones or speakers. Further, the AR system 201 may also have one or more display(s) 208 that permit the AR system 201 to overlay and/or display information to the user in addition to provide the user with a view of the user's environment presented as by the AR system 201. The AR system 201 may also include one or more communication interface(s) 206, which enable information to be communicated to one or more computer systems (e.g., a gaming system, a different AR or other XR system, or other system capable of rendering or receiving AR data). The information may be communicated via an Internet communication or via another communication technology known in the art. AR systems can take many forms and are available from a number of different manufacturers. For example, various embodiments may be implemented in association with one or more types of AR systems, such as HoloLens holographic reality glasses available from the Microsoft Corporation (Redmond, Wash., USA), Lightwear AR headset from Magic Leap (Plantation, Fla., USA), Google Glass AR glasses available from Alphabet (Mountain View, Calif., USA), R-7 Smartglasses System available from Osterhout Design Group (also known as ODG; San Francisco, Calif., USA), or any other type of AR or other XR device. Although discussed using AR by way of example, it should be appreciated that one or more embodiments may be implemented within XR systems.

The AR system 201 may be operatively coupled to the neuromuscular activity system 202 through one or more communication schemes or methodologies, including but not limited to, Bluetooth protocol, Wi-Fi, Ethernet-like protocols, or any number of connection types, wireless and/or wired. It should be appreciated that, for example, systems 201 and 202 may be directly connected or coupled through one or more intermediate computer systems or network elements. The double-headed arrow in FIG. 2 represents the communicative coupling between the systems 201 and 202.

As mentioned earlier, the neuromuscular activity system 202 may be similar in structure and function to the system 100 described above with reference to FIG. 1. In particular, the system 202 may include one or more neuromuscular sensor(s) 209, one or more inference mode(l)s 210, and may create, maintain, and store a musculoskeletal representation 211. In an example embodiment, similar to one discussed above, the system 202 may include or may be implemented as a wearable device, such as a band that can be worn by a user, in order to obtain and analyze neuromuscular signals from the user. Further, the system 202 may include one or more communication interface(s) 212 that permit the system 202 to communicate with the AR system 201, such as by Bluetooth, Wi-Fi, or other communication method. Notably, the AR system 201 and the neuromuscular activity system 202 may communicate information that can be used to enhance user experience and/or allow the AR system 201 to function more accurately and effectively.

While FIG. 2 shows a distributed computer-based system 200 that integrates the AR system 201 with the neuromuscular activity system 202, it will be understood that integration of these systems 201 and 202 may be non-distributed in nature. In some embodiments, the neuromuscular activity system 202 may be integrated into the AR system 201 such that the various components of the neuromuscular activity system 202 may be considered as part of the AR system 201. For example, inputs from the neuromuscular sensor(s) 209 may be treated as another of the inputs (e.g., from the camera(s) 204, from the sensor(s) 207) to the AR system 201. In addition, processing of the inputs (e.g., sensor signals) obtained from the neuromuscular sensors 209 may be integrated into the AR system 201.

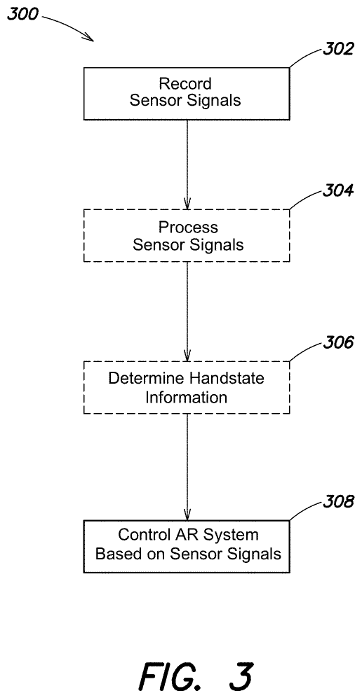

FIG. 3 illustrates a process 300 for controlling an AR system, such as the AR system 201 of the AR-based system 200 comprising the AR system 201 and the neuromuscular activity system 202, in accordance with some embodiments of the technology described herein. The process 300 may be performed at least in part by the neuromuscular activity system 202 of the AR-based system 200. In act 302, sensor signals (also referred to herein as “raw sensor signals”) may be sensed and recorded by one or more sensor(s) of the neuromuscular activity system 202. In some embodiments, the sensor(s) may include a plurality of neuromuscular sensors 209 (e.g., EMG sensors) arranged on a wearable device worn by a user. For example, the sensors 209 may be EMG sensors arranged on an elastic band configured to be worn around a wrist or a forearm of the user to record neuromuscular signals from the user as the user performs various movements or gestures. In some embodiments, the EMG sensors may be the sensors 504 arranged on the band 502, as shown in FIG. 5; in some embodiments, the EMG sensors may be the sensors 610 arranged on the band 620, as shown in FIG. 6A. The gestures performed by the user may include static gestures, such as placing the user's hand palm down on a table; dynamic gestures, such as waving a finger back and forth; and covert gestures that are imperceptible to another person, such as slightly tensing a joint by co-contracting opposing muscles, or using sub-muscular activations. The gestures performed by the user may include symbolic gestures (e.g., gestures mapped to other gestures, interactions, or commands, for example, based on a gesture vocabulary that specifies the mapping).

In addition to a plurality of neuromuscular sensors, some embodiments of the technology described herein may include one or more auxiliary sensor(s) configured to sense and record auxiliary signals that may also be provided as input to the one or more trained inference model(s), as discussed above. Examples of auxiliary sensors include IMUs, imaging devices, radiation detection devices (e.g., laser scanning devices), heart rate monitors, or any other type of biosensors configured to sense and record biophysical information from a user during performance of one or more movements or gestures. Further, it should be appreciated that some embodiments may be implemented using camera-based systems that perform skeletal tracking, such as, for example, the Kinect system available from the Microsoft Corporation (Redmond, Wash., USA) and the LeapMotion system available from Leap Motion, Inc. (San Francisco, Calif., USA). It should be appreciated that any combination of hardware and/or software may be used to implement various embodiments described herein.

At act 304, raw sensor signals, which may include the signals sensed and recorded by the one or more sensor(s) (e.g., EMG sensors, auxiliary sensors, etc.), as well as optional camera input signals from one more camera(s), may be optionally processed. In some embodiments, the raw sensor signals may be processed using hardware signal-processing circuitry (e.g., to perform amplification, filtering, and/or rectification). In other embodiments, at least some signal processing of the raw sensor signals may be performed using software. Accordingly, signal processing of the raw sensor signals, sensed and recorded by the one or more sensor(s) and optionally obtained from the one or more camera(s), may be performed using hardware, or software, or any suitable combination of hardware and software. In some implementations, the raw sensor signals may be processed to derive other signal data. For example, accelerometer data recorded by one or more IMU(s) may be integrated and/or filtered to determine derived signal data associated with one or more muscles during activation of a muscle or performance of a gesture.

The process 300 then proceeds to act 306, where the raw sensor signals or the processed sensor signals of act 304 are optionally provided as input to the trained inference model(s), which is or are configured to determine and output information representing user activity, such as handstate information and/or muscular activation state information (e.g., a gesture, a pose, etc.), as described above.

The process 300 then proceeds to act 308, where control of the AR system 201 is performed based on the raw sensor signals, the processed sensor signals, and/or the output(s) of the trained inference model(s) (e.g., the handstate information and/or other rendered output of the trained inference model(s), etc.). In some embodiments, control of the AR system 201 may be performed based on one or more muscular activation states identified from the raw sensor signals, the processed sensor signals, and/or the output(s) of the trained inference model(s). In some embodiments, the AR system 201 may receive a rendered output that the AR system 210 can display as a rendered gesture or cause another device (e.g., a robotic device) to mimic.

According to some embodiments, one or more computer processors (e.g., the processor(s) 104 of the system 100, or the processor(s) 205 of the AR-based system 200) may be programmed to identify one or more muscular activation states of a user from raw sensor signals (e.g., signals sensed and recorded by the one or more sensor(s) discussed above, optionally including the camera input signals discussed above) and/or information based on these signals (e.g., information derived from processing the raw signals), and to output one or more control signal(s) to control an AR system (e.g., the AR system 201). The information based on the raw sensor signals may include information associated with processed sensor signals (e.g., processed EMG signals) and/or information associated with outputs of the trained inference model(s) (e.g., handstate information). The one or more muscular activation states of the user may include a static gesture performed by the user (e.g., a pose), a dynamic gesture performed by the user (e.g., a movement), a sub-muscular activation state of the user (e.g., a muscle tensing). The one or more muscular activation states of the user may be defined by one or more pattern(s) of muscle activity and/or one or more motor unit activation(s) detected in the raw sensor signals and/or information based on the raw sensor signals, associated with various movements or gestures performed by the user.

In some embodiments, one or more control signal(s) may be generated and communicated to the AR system (e.g., the AR system 201) based on the identified one or more muscular activation states. The one or more control signals may control various aspects and/or operations of the AR system. The one or more control signal(s) may trigger or otherwise cause one or more actions or functions to be performed that effectuate control of the AR system.

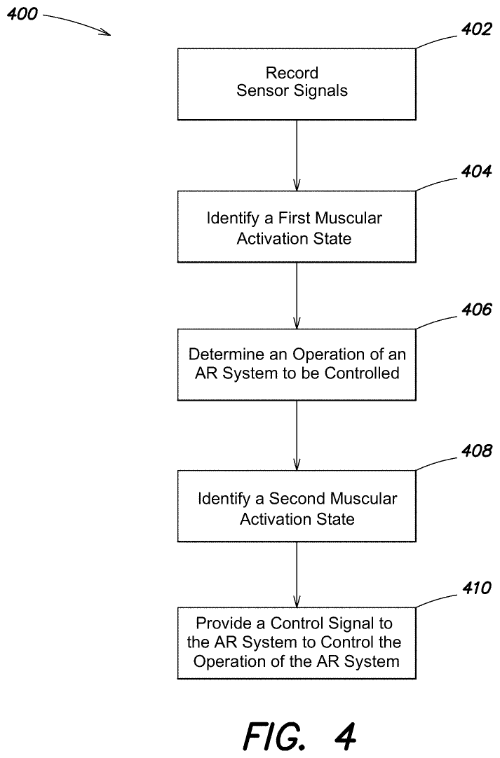

FIG. 4 illustrates a process 400 for controlling an AR system, such as the AR system 201 of the AR-based system 200 comprising the AR system 201 and the neuromuscular activity system 202, in accordance with some embodiments of the technology described herein. The process 400 may be performed at least in part by the neuromuscular activity system 202 of the AR-based system 200. In act 402, sensor signals are sensed and recorded by one or more sensor(s), such as neuromuscular sensors (e.g., EMG sensors) and/or auxiliary sensors (e.g., IMUs, imaging devices, radiation detection devices, heart rate monitors, other types of biosensors, etc.) of the neuromuscular activity system 202. For example, the sensor signals may be obtained from a user wearing a wristband on which the one or more sensor(s) is or are attached.

In act 404, a first muscular activation state of the user may be identified based on raw signals and/or processed signals (collectively “sensor signals”) and/or information based on or derived from the raw signals and/or the processed signals, as discussed above (e.g., handstate information). In some embodiments, one or more computer processor(s) (e.g., the processor(s) 104 of the system 100, or the processor(s) 205 of the AR-based system 200) may be programmed to identify the first muscular activation state based on any one or any combination of: the sensor signals, the handstate information, static gesture information (e.g., pose information, orientation information), dynamic gesture information (movement information), information on motor-unit activity (e.g., information on sub-muscular activation) etc.

In act 406, an operation of the AR system to be controlled is determined based on the identified first muscular activation state of the user. For example, the first muscular activation state may indicate that the user wants to control a brightness of a display device associated with the AR system. In some implementations, in response to the determination of the operation of the AR system to be controlled, the one or more computer processors (e.g., 104 of the system 100 or 205 of the system 200) may generate and communicate a first control signal to the AR system. The first control signal may include identification of the operation to be controlled. The first control signal may include an indication to the AR system regarding the operation of the AR system to be controlled. In some implementations, the first control signal may trigger an action at the AR system. For example, receipt of the first control signal may cause the AR system to display a screen associated with the display device (e.g., a settings screen via which brightness can be controlled). In another example, receipt of the first control signal may cause the AR system to communicate to the user (e.g., by displaying within an AR environment provided by the AR system) one or more instructions about how to control the operation of the AR system using muscle activation sensed by the neuromuscular activity system. For instance, the one or more instructions may indicate that an upward swipe gesture can be used to increase the brightness of the display and/or a downward swipe gesture can be used to decrease the brightness of the display. In some embodiments, the one or more instructions may include a visual demonstration and/or a textual description of how one or more gesture(s) can be performed to control the operation of the AR system. In some embodiments, the one or more instructions may implicitly instruct the user, for example, via a spatially arranged menu that implicitly instructs that an upward swipe gesture can be used to increase the brightness of the display. Optionally, the receipt of the first control signal may cause the AR system to provide one or more audible instructions about how to control the operation of the AR system using muscle activation sensed by the neuromuscular activity system. For instance, the one or more voiced instructions may instruct that moving an index finger of a hand toward a thumb of the hand in a pinching motion can be used to decrease the brightness of the display and/or that moving the index finger and the thumb away from each other may increase the brightness of the display.

In act 408, a second muscular activation state of the user may be identified based on the sensor signals and/or information based on or derived from the sensor signals (e.g., handstate information). In some embodiments, the one or more computer processors (e.g., 104 of the system 100 or 205 of the system 200) may be programmed to identify the second muscular activation state based on any one or any combination of: neuromuscular sensor signals, auxiliary sensor signals, handstate information, static gesture information (e.g., pose information, orientation information), dynamic gesture information (movement information), information on motor-unit activity (e.g., information on sub-muscular activation) etc.

In act 410, a control signal may be provided to the AR system to control the operation of the AR system based on the identified second muscular activation state. For example, the second muscular activation state may include one or more second muscular activation states, such as, one or more upward swipe gestures to indicate that the user wants to increase the brightness of the display device associated with the AR system, one or more downward swipe gestures to indicate that the user wants to decrease the brightness of the display device, and/or a combination of upward and downward swipe gestures to adjust the brightness to a desired level. The one or more computer processors may generate and communicate one or more second control signal(s) to the AR system. In some implementations, the second control signal(s) may trigger the AR system to increase the brightness of the display device based on the second muscular activation state. For example, receipt of the second control signal(s) may cause the AR system to increase or decrease the brightness of the display device and manipulate a slider control in the settings screen to indicate such increase or decrease.

In some embodiments, the first muscular activation state and/or the second muscular activation state may include a static gesture (e.g., an arm pose) performed by the user. In some embodiments, the first muscular activation state and/or the second muscular activation state may include a dynamic gesture (e.g., an arm movement) performed by the user. In other embodiments, the first muscular activation state and/or the second muscular activation state may include a sub-muscular activation state of the user. In yet other embodiments, the first muscular activation state and/or the second muscular activation state may include muscular tensing performed by the user, which may not be readily seen by someone observing the user.

Although FIG. 4 describes controlling a brightness of the display device based on two (e.g., first and second) muscular activation states, it will be appreciated that such control can be achieved based on one muscular activation state or more than two muscular activation states, without departing from the scope of this disclosure. In a case where there is only one muscular activation state, that muscular activation state may be used to determine or select the operation of the AR system to be controlled and also to provide the control signal to the AR system to control the operation. For example, a muscular activation state (e.g., an upward swipe gesture) may be identified that indicates that the user wants to increase the brightness of the display and a control signal may be provided to the AR system to increase the brightness based on the single muscular activation state.

Although FIG. 4 has been described with respect to control signals generated and communicated to the AR system to control the brightness of a display device associated with the AR system, it will be understood that one or more muscular activation states may be identified and appropriate one or more control signal(s) may be generated and communicated to the AR system to control different aspects/operations of the AR system. For example, a control signal may include a signal to turn on or off the display device associated with the AR system

In some embodiments, a control signal may include a signal for controlling an attribute of an audio device associated with the AR system, such as, by triggering the audio device to start or stop recording audio or changing the volume, muting, pausing, starting, skipping and/or otherwise changing the audio associated with the audio device.

In some embodiments, a control signal may include a signal for controlling a privacy mode or privacy setting of one or more devices associated with the AR system. Such control may include enabling or disabling certain devices or functions (e.g., cameras, microphones, and other devices) associated with the AR system and/or controlling information that is processed locally vs. information that is processed remotely (e.g., by one or more servers in communication with the AR system via one or more networks).

In some embodiments, a control signal may include a signal for controlling a power mode or a power setting of the AR system.

In some embodiments, a control signal may include a signal for controlling an attribute of a camera device associated with the AR system, such as, by triggering a camera device (e.g., a head-mounted camera device) to capture one or more frames, triggering the camera device to start or stop recording a video, or changing a focus, zoom, exposure or other settings of the camera device.

In some embodiments, a control signal may include a signal for controlling a display of content provided by the AR system, such as by controlling the display of navigation menus and/or other content presented in a user interface displayed in an AR environment provided by the AR system.

In some embodiments, a control signal may include a signal for controlling information to be provided by the AR system, such as, by skipping information (e.g., steps or instructions) associated with an AR task (e.g., AR training). In an embodiment, the control signal may include a request for specific information to be provided by the AR system, such as display of a name of the user or other person in the field of view, where the name may be displayed as plain text, stationary text, or animated text.

In some embodiments, a control signal may include a signal for controlling communication of information associated with the AR system to a second AR system associated with another person different from the user of the AR system or to another computing device (e.g., cell phone, smartwatch, computer, etc.). In one embodiment, the AR system may send any one or any combination of text, audio, and video signals to the second AR system or other computing device. In another embodiment, the AR system may communicate covert signals to the second AR system or other computing device. The second AR system or other computing device may interpret the information sent in the signals and display the interpreted information in a personalized manner (i.e., personalized according to the other person's preferences). For example, the covert signals may cause the interpreted information to be provided only to the other person via, e.g., a head-mounted display device, earphones, etc.

In some embodiments, a control signal may include a signal for controlling a visualization of the user (e.g., to change an appearance of the user) generated by the AR system. In one embodiment, a control signal may include a signal for controlling a visualization of an object or a person other than the user, where the visualization is generated by the AR system.

In some embodiments, a first muscular activation state detected from the user may be used to determine that a wake-up mode of the AR system is to be controlled. A second muscular activation state detected from the user may be used to control an initialization operation of the wake-up mode of the XR system.

It will be appreciated that while FIG. 4 describes a first muscular activation state and a second muscular activation state, additional or alternative muscular activation state(s) may be identified and used to control various aspects/operations of the AR system, to enable a layered or multi-level approach to controlling the AR system. For instance, the AR system may be operating in a first mode (e.g., a game playing mode) when the user desires a switch to a second mode (e.g., a control mode) for controlling operations of the AR system. In this scenario, a third muscular activation state of the user may be identified based on the raw signals and/or processed signals (i.e., the sensor signals) and/or the information based on or derived from the sensor signals (e.g., handstate information), where the third muscular activation state may be identified prior to the first and second muscular activation states. The operation of the AR system may be switched/changed from the first mode to the second mode based on the identified third muscular activation state. As another example, once in the control mode, a fourth muscular activation state may be identified based on the sensor signals and/or the information based on the sensor signals (e.g., handstate information), where the fourth muscular activation state may be identified after the third muscular activation state and prior to the first and second muscular activation states. A particular device or function (e.g., display device, camera device, audio device, etc.) associated with the AR system may be selected for control based on the fourth muscular activation state.

In some embodiments, a plurality of first (and/or a plurality of second, and/or a plurality of third) muscular activation states may be detected or sensed from the user. For example, the plurality of first muscular activation states may correspond to a repetitive muscle activity of the user (e.g., a repetitive tensing of the user's right thumb, a repetitive curling of the user's left index finger, etc.). Such repetitive activity may be associated with a game-playing AR environment (e.g., repeated pulling of a firearm trigger in a skeet-shooting game, etc.).

In some embodiments, the AR system may have a wake-up or initialization mode and/or an exit or shut-down mode. The muscular activation states detected or sensed from the user may be used to wake up the AR system and/or to shut down the AR system.

According to some embodiments, the sensor signals and/or the information based on the sensor signals may be interpreted based on information received from the AR system. For instance, information indicating a current state of the AR system may be received where the received information is used to inform how the one or more muscular activation state(s) are identified from the sensor signals and/or the information based on the sensor signals. As an example, when the AR system is currently displaying information, certain aspects of the display device may be controlled via the one or more muscular activation state(s). When the AR system is currently recording video, certain aspects of the camera device may be controlled via the same one or more muscular activation state(s) or via one or more different muscular activation state(s). In some embodiments, one or more same gestures could be used to control different aspects of the AR system based on the current state of the AR system.

The above-described embodiments can be implemented in any of numerous ways. For example, the embodiments may be implemented using hardware, or software, or a combination thereof. When implemented using software, code comprising the software can be executed on any suitable processor or a collection of processors, whether provided in a single computer or distributed among multiple computers. It should be appreciated that any component or collection of components that perform the functions described above can be generically considered as one or more controllers that control the above-discussed functions. The one or more controllers can be implemented in numerous ways, such as with dedicated hardware or with one or more processors programmed using microcode or software to perform the functions recited above.

In this respect, it should be appreciated that one implementation of the embodiments of the present invention comprises at least one non-transitory computer-readable storage medium (e.g., a computer memory, a portable memory, a compact disk, etc.) encoded with a computer program (i.e., a plurality of instructions), which, when executed on a processor, performs the above-discussed functions of the embodiments of the technologies described herein. The at least one computer-readable storage medium can be transportable such that the program stored thereon can be loaded onto any computer resource to implement the aspects of the present invention discussed herein. In addition, it should be appreciated that reference to a computer program that, when executed, performs the above-discussed functions, is not limited to an application program running on a host computer. Rather, the term computer program is used herein in a generic sense to reference any type of computer code (e.g., software or microcode) that can be employed to program a processor to implement the above-discussed aspects of the present invention. As will be appreciated a first portion of the program may be executed on a first computer processor and a second portion of the program may be executed on a second computer processor different from the first computer processor. The first and second computer processors may be located at the same location or at different locations; in each scenario the first and second computer processors may be in communication with each other via, e.g., a communication network.

Various aspects of the technology presented herein may be used alone, in combination, or in a variety of arrangements not specifically discussed in the embodiments described above and therefore are not limited in their application to the details and arrangements of components set forth in the foregoing description and/or in the drawings.

Also, some of the embodiments described above may be implemented as one or more method(s), of which some examples have been provided. The acts performed as part of the method(s) may be ordered in any suitable way. Accordingly, embodiments may be constructed in which acts are performed in an order different than illustrated or described herein, which may include performing some acts simultaneously, even though shown as sequential acts in illustrative embodiments.

The phraseology and terminology used herein is for the purpose of description and should not be regarded as limiting. The use of “including,” “comprising,” “having,” “containing”, “involving”, and variations thereof, is meant to encompass the items listed thereafter and additional items.

Having described several embodiments of the invention in detail, various modifications and improvements will readily occur to those skilled in the art. Such modifications and improvements are intended to be within the spirit and scope of the invention. Accordingly, the foregoing description is by way of example only, and is not intended as limiting. The invention is limited only as defined by the following claims and the equivalents thereto.

The foregoing features may be used, separately or together in any combination, in any of the embodiments discussed herein.

Further, although advantages of the technology described herein may be indicated, it should be appreciated that not every embodiment of the invention will include every described advantage. Some embodiments may not implement any features described as advantageous herein. Accordingly, the foregoing description and attached drawings are by way of example only.

Variations on the disclosed embodiment are possible. For example, various aspects of the present technology may be used alone, in combination, or in a variety of arrangements not specifically discussed in the embodiments described in the foregoing, and therefore they are not limited in application to the details and arrangements of components set forth in the foregoing description or illustrated in the drawings. Aspects described in one embodiment may be combined in any manner with aspects described in other embodiments.

Use of ordinal terms such as “first,” “second,” “third,” etc., in the description and/or the claims to modify an element does not by itself connote any priority, precedence, or order of one element over another, or the temporal order in which acts of a method are performed, but are used merely as labels to distinguish one element or act having a certain name from another element or act having a same name (but for use of the ordinal term) to distinguish the elements or acts.

The indefinite articles “a” and “an,” as used herein in the specification and in the claims, unless clearly indicated to the contrary, should be understood to mean “at least one.”

Any use of the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified.

Any use of the phrase “equal” or “the same” in reference to two values (e.g., distances, widths, etc.) means that two values are the same within manufacturing tolerances. Thus, two values being equal, or the same, may mean that the two values are different from one another by ±5%.

The phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of.” “Consisting essentially of,” when used in the claims, shall have its ordinary meaning as used in the field of patent law.

Also, the phraseology and terminology used herein is for the purpose of description and should not be regarded as limiting. Use of terms such as “including,” “comprising,” “comprised of,” “having,” “containing,” and “involving,” and variations thereof herein, is meant to encompass the items listed thereafter and equivalents thereof as well as additional items.

The terms “approximately” and “about” if used herein may be construed to mean within ±20% of a target value in some embodiments, within ±10% of a target value in some embodiments, within ±5% of a target value in some embodiments, and within ±2% of a target value in some embodiments. The terms “approximately” and “about” may equal the target value.

The term “substantially” if used herein may be construed to mean within 95% of a target value in some embodiments, within 98% of a target value in some embodiments, within 99% of a target value in some embodiments, and within 99.5% of a target value in some embodiments. In some embodiments, the term “substantially” may equal 100% of the target value.

What is claimed is:

1. A computerized system for controlling an augmented reality (AR) system based on neuromuscular signals, the system comprising:
a plurality of neuromuscular sensors configured to record a plurality of neuromuscular signals from a user, wherein the plurality of neuromuscular sensors are arranged on one or more wearable devices; and
at least one computer processor programmed to:
identify a first muscular activation state of the user based on the plurality of neuromuscular signals,
determine, based on the first muscular activation state, an operation of the augmented reality system to be controlled,
identify a second muscular activation state of the user based on the plurality of neuromuscular signals, and
provide, based on the second muscular activation state, a control signal to the AR system to control the operation of the AR reality system.

2. The computerized system of claim 1, wherein the first muscular activation state, or the second muscular activation state, or both the first and second muscular activation states comprise a static gesture performed by the user.

3. The computerized system of claim 1, wherein the first muscular activation state, or the second muscular activation state, or both the first and second muscular activation states comprise a dynamic gesture performed by the user.

4. The computerized system of claim 1, wherein the first muscular activation state, or the second muscular activation state, or both the first and second muscular activation states comprise a sub-muscular activation state.

5. The computerized system of claim 1, wherein the first muscular activation state, or the second muscular activation state, or both the first and second muscular activation states comprise a muscular tensing performed by the user.

6. The computerized system of claim 1, wherein the first muscular activation state is same as the second muscular activation state.

7. The computerized system of claim 1, wherein the control signal comprises a signal for controlling a brightness of a display device associated with the AR system.

8. The computerized system of claim 1, wherein the control signal comprises a signal for controlling an attribute of an audio device associated with the AR system.

9. The computerized system of claim 1, wherein the control signal comprises a signal for controlling a privacy mode or privacy setting of one or more devices associated with the AR system.

10. The computerized system of claim 1, wherein the control signal comprises a signal for controlling a power mode or a power setting of the AR system.

11. The computerized system of claim 1, wherein the control signal comprises a signal for controlling an attribute of a camera device associated with the AR system.

12. The computerized system of claim 1, wherein the control signal comprises a signal for controlling a display of content by the AR system.

13. The computerized system of claim 1, wherein the control signal comprises a signal for controlling information to be provided by the AR system.

14. The computerized system of claim 1, wherein the control signal comprises a signal for controlling communication of information associated with the AR system to a second AR system.

15. The computerized system of claim 1, wherein the control signal comprises a signal for controlling a visualization of the user generated by the AR system.

16. The computerized system of claim 1, wherein the control signal comprises a signal for controlling a visualization of an object or a person other than the user, wherein the visualization is generated by the AR system.

17. The computerized system of claim 1, wherein the at least one computer processor is further programmed to:
present to the user via a user interface displayed in an AR environment provided by the AR system, one or more instructions about how to control the operation of the AR system.

18. The computerized system of claim 17, wherein the one or more instructions include a visual demonstration of how to achieve the first muscular activation state, or the second muscular activation state, or both the first and second muscular activation states.

19. The computerized system of claim 1, wherein the at least one computer processor is further programmed to:
receive information from the AR system indicating a current state of the AR system, wherein the plurality of neuromuscular signals are interpreted based on the received information.

20. The computerized system of claim 1, wherein the AR system is configured to operate in a first mode, and wherein the at least one computer processor is further programmed to:
identify a third muscular activation state of the user based on the plurality of neuromuscular signals, wherein the third muscular activation state is identified prior to the first and second muscular activation states, and
change, based on the third muscular activation state, an operation mode of the AR system from the first mode to a second mode, wherein the second mode is a mode for controlling operations of the AR system.

21. The computerized system of claim 1, wherein the at least one computer processor is further programmed to:
identify a plurality of second muscular activation states of the user based on the plurality of neuromuscular signals, the plurality of second muscular activation states including the second muscular activation state, and
provide, based on the plurality of second muscular activation states, a plurality of control signals to the AR system to control the operation of the AR system.

22. The computerized system of claim 21, wherein the at least one computer processor is further programmed to:
identify a plurality of third muscular activation states of the user based on the plurality of neuromuscular signals, and
provide, based on the plurality of second muscular activation states, or the plurality of third muscular activation states, or both the plurality of second muscular activation states and the plurality of third muscular activation states, the plurality of control signals to the AR system to control the operation of the AR system.

23. A method for controlling an augmented reality (AR) system based on neuromuscular signals, the method comprising:
recording, using a plurality of neuromuscular sensors arranged on one or more wearable devices, a plurality neuromuscular signals from a user;
identifying a first muscular activation state of the user based on the plurality of neuromuscular signals;
determining, based on the first muscular activation state, an operation of the augmented reality system to be controlled;
identifying a second muscular activation state of the user based on the plurality of neuromuscular signals; and
providing, based on the second muscular activation state, a control signal to the AR system to control the operation of the AR system.

24. A computerized system for controlling an augmented reality (AR) system based on neuromuscular signals, the system comprising:
a plurality of neuromuscular sensors configured to record a plurality of neuromuscular signals from a user, wherein the plurality of neuromuscular sensors are arranged on one or more wearable devices; and
at least one computer processor programmed to:
identify a muscular activation state of the user based on the plurality of neuromuscular signals,
determine, based on the muscular activation state, an operation of the AR system to be controlled, and
provide, based on the muscular activation state, a control signal to the AR system to control the operation of the AR system.

25. The computerized system of claim 24, wherein the control signal comprises a signal for controlling any one or any combination of:
a brightness of a display device associated with the AR system,
an attribute of an audio device associated with the AR system,
a privacy mode or privacy setting of one or more devices associated with the AR system,
a power mode or a power setting of the AR system, and
an attribute of a camera device associated with the AR system.

26. The computerized system of claim 24, wherein the control signal comprises a signal for controlling any one or any combination of:
a display of content by the AR system,
information to be provided by the AR system, and
communication of information associated with the AR system to a second AR system.

27. The computerized system of claim 24, wherein the control signal comprises a signal for controlling any one or any combination of:
a visualization of the user generated by the AR system, and
a visualization of an object or a person other than the user, wherein the visualization is generated by the AR system.

28. The computerized system of claim 24, wherein the at least one computer processor is further programmed to:
present to the user via a user interface displayed in an AR environment provided by the AR system, one or more instructions about how to control the operation of the AR system.

29. The computerized system of claim 28, wherein the one or more instructions include a visual demonstration of how to achieve the first muscular activation state, or the second muscular activation state, or both the first and second muscular activation states.

30. The computerized system of claim 24, wherein the at least one computer processor is further programmed to:
receive information from the AR system indicating a current state of the AR system, wherein the plurality of neuromuscular signals are interpreted based on the received information.
